(19) United States
(12) Patent Application Publication
(10) Pub. No.: US 2016/0219636 A1
(43) Pub. Date: Jul. 28, 2016

(54) USER TERMINAL AND MOBILE COMMUNICATION SYSTEM

(71) Applicant: KYOCERA CORPORATION, Kyoto (JP)

(72) Inventors: Masato FUJISHIRO, Yokohama-shi (JP); Kugo MORITA, Yokohama-shi (JP); Chiharu YAMAZAKI, Ota-ku (JP); Naohisa MATSUMOTO, Kawasaki-shi (JP)

(73) Assignee: KYOCERA CORPORATION, Kyoto (JP)

(21) Appl. No.: 14/914,197

(22) PCT Filed: Aug. 25, 2014
(86) PCT No.: PCT/JP2014/072179

§ 371 Date: Feb. 24, 2016

Related U.S. Application Data
(60) Provisional application No. 61/934,413, filed on Jan. 31, 2014.

(30) Foreign Application Priority Data
Aug. 28, 2013 (JP) 2013-176504

(51) Int. Cl. H04W 76/02; H04W 64/00; H04W 72/04

(52) U.S. Cl. CPC H04W 76/023; H04W 72/0453; H04W 72/0446; H04W 64/003

(57) ABSTRACT

A UE 100 determining an assignment pattern of a radio resource used for D2D communication that is direct device-to-device communication when the UE 100 performs the D2D communication in a D2D group including a plurality of UEs 100, is comprised. The UE 100 determines, on the basis of a temporary identifier assigned from a network, the assignment pattern such that the radio resource used for the D2D communication is dispersed in a frequency direction and/or a time direction.

### TECHNICAL FIELD

The prevent invention relates to a user terminal used in a mobile communication system that supports D2D communication, and the mobile communication system.

### BACKGROUND ART

In 3GPP (3rd Generation Partnership Project) which is a project aiming to standardize a mobile communication system, the introduction of Device to Device (D2D) communication is discussed as a new function after Release 12 (see Non Patent Document 1).

In the D2D communication, in a terminal group including a plurality of adjacent user terminals, direct device-to-device communication is performed without passing through a network. On the other hand, in cellular communication which is normal communication in a mobile communication system, a user terminal performs communication through a network.

In the D2D communication, since radio communication with low transmission power can be performed between adjacent user terminals, power consumption of the user terminal and a load on the network can be reduced in comparison with the cellular communication.

### PRIOR ART DOCUMENT

### Non-Patent Document

Non Patent Document 1: 3GPP technical report “TR 22.803 V12.1.0” March, 2013

### SUMMARY OF THE INVENTION

In terms of reducing a load on a network, a terminal-led scheduling is preferable, by which an assignment of a radio resource used for D2D communication is performed under the initiative of a user terminal. For example, a user terminal included in a terminal group determines a radio resource used for D2D communication, and the determined radio resource is used for D2D communication in the terminal group.

However, in the terminal-led scheduling, a radio resource used for D2D communication in the terminal group may coincide with a radio resource used for cellular communication or a radio resource used for D2D communication in another terminal group.

Therefore, by the terminal-led scheduling, it is possible to reduce a load on a network, but it may cause D2D communication to become disabled due to interference to the D2D communication.

Thus, an object of the present invention is to reduce a load on a network and to prevent D2D communication from becoming disabled due to interference.

A user terminal according to an aspect of the present invention is used in a mobile communication system. The user terminal comprises: a controller configured to determine, when D2D communication that is direct device-to-device communication is performed in a terminal group including a plurality of user terminals, an assignment pattern of a radio resource used for the D2D communication. The controller determines, on the basis of a temporary identifier assigned from a network of the mobile communication system, the assignment pattern such that the radio resource used for the D2D communication is dispersed in a frequency direction and/or a time direction.

### BRIEF DESCRIPTION OF THE DRAWINGS

FIG. 1 is a configuration diagram of an LTE system according to a first embodiment to a fourth embodiment.

FIG. 2 is a block diagram of a UE according to the first embodiment to the fourth embodiment.

FIG. 3 is a block diagram of an eNB according to the first embodiment to the fourth embodiment.

FIG. 4 is a protocol stack diagram of a radio interface according to the first embodiment to the fourth embodiment.

FIG. 5 is a configuration diagram of a radio frame according to the first embodiment to the fourth embodiment.

FIG. 6 is a diagram for describing D2D communication according to the first embodiment to the fourth embodiment.

FIG. 7 is a diagram showing a data path in cellular communication according to the first embodiment to the fourth embodiment.

FIG. 8 is a diagram showing a data path in the D2D communication according to the first embodiment to the fourth embodiment.

FIG. 9 is a diagram for describing an operation environment according to the first embodiment to the third embodiment.

FIG. 10 is an operation sequence chart according to the first embodiment.

FIG. 11 is a diagram for describing a method of determining a D2D resource assignment pattern according to the first embodiment.

FIG. 12 is a diagram for describing a D2D-RNTI according to a second embodiment.

FIG. 13 is a diagram for describing a C-RNTI according to the second embodiment.

FIG. 14 is a diagram for describing a specific example of D2D-transmission-and-reception assignment according to the second embodiment.

FIG. 15 is a configuration diagram of a radio frame in a mobile communication system according to a fourth embodiment.

FIG. 16 is an explanatory diagram for describing an operation example 1-1 according to the fourth embodiment.

FIG. 17 is a flowchart for describing an example of the operation example 1-1 according to the fourth embodiment.

FIG. 18 is an explanatory diagram for describing a first modification of the operation example 1-1 according to the fourth embodiment.

FIG. 19 is an explanatory diagram for describing a second modification of the operation example 1-1 according to the fourth embodiment.

FIG. 20 is an explanatory diagram for describing an operation example 1-2 according to the fourth embodiment.

FIG. 21 is an explanatory diagram for describing an operation example 1-3 according to the fourth embodiment.

FIG. 22 is a flowchart for describing an example of the operation example 1-3 according to the fourth embodiment.

FIG. 23 is a configuration diagram of the radio frame in the mobile communication system according to the fourth embodiment.

FIG. 24 is a configuration diagram of the radio frame in the mobile communication system according to the fourth embodiment.

FIG. 25 is a flowchart for describing an operation of a UE 100 according to the fourth embodiment.

FIG. 26 is a flowchart for describing the operation of the UE 100 according to the fourth embodiment.

FIG. 27 is a configuration diagram of the radio frame in the mobile communication system according to the fourth embodiment.

FIG. 28 is a configuration diagram of the radio frame in the mobile communication system according to the fourth embodiment.

FIG. 29 is a configuration diagram of the radio frame in the mobile communication system according to the fourth embodiment.

FIG. 30 is a flowchart for describing an operation of transmitting a collision notification by the UE 100 according to the fourth embodiment.

FIG. 31 is a flowchart for describing an operation of receiving a collision notification by the UE 100 according to the fourth embodiment.

FIG. 32 is a diagram for describing an example of subset division random resource selection.

FIG. 33 is a diagram for describing comparison of random resource selection and the subset division random resource selection.

### DESCRIPTION OF THE EMBODIMENT

[Overview of Embodiments]

A user terminal according to a first embodiment to a third embodiment is used in a mobile communication system. The user terminal comprises: a controller configured to determine, when D2D communication that is direct device-to-device communication is performed in a terminal group including a plurality of user terminals, an assignment pattern of a radio resource used for the D2D communication. The controller determines, on the basis of a temporary identifier assigned from a network of the mobile communication system, the assignment pattern such that the radio resource used for the D2D communication is dispersed in a frequency direction and/or a time direction.

In the first embodiment to the third embodiment, the temporary identifier is a group identifier for identifying the terminal group. The controller determines, on the basis of the group identifier assigned from the network, the assignment pattern such that the radio resource used for the D2D communication is dispersed in the frequency direction and/or the time direction.

In the second embodiment, the group identifier includes different intra-group identification information for each user terminal included in the terminal group. The controller determines, on the basis of the intra-group identification information included in the group identifier assigned to the user terminal, whether to perform transmission or to perform reception in the radio resource used for the D2D communication.

In the third embodiment, the terminal group is a group including a plurality of user terminals between which device-to-device synchronization is performed.

In the third embodiment, the terminal group is a group including a plurality of user terminals between which device-to-device synchronization is performed and which transmit and receive data through the D2D communication.

In the third embodiment, a plurality of data distribution systems are defined as a data distribution system for transmitting and receiving data through the D2D communication. The plurality of data distribution systems are at least two of unicast distribution, group cast distribution, and broadcast distribution. The terminal group is set for each of the data distribution systems.

In the third embodiment, when the user terminal belongs to a plurality of terminal groups that are set for each of the data distribution systems, a plurality of group identifiers corresponding to the plurality of terminal groups are assigned to the user terminal. The controller determines, on the basis of the plurality of group identifiers, the assignment pattern of the radio resource used for the D2D communication for each of the plurality of terminal groups.

In the first embodiment and the second embodiment, the temporary identifier is a terminal identifier for identifying each user terminal. The controller determines, on the basis of the terminal identifier assigned from the network to a representative user terminal included in the terminal group, the assignment pattern such that the radio resource used for the D2D communication is dispersed in the frequency direction and/or the time direction.

In the second embodiment, the terminal identifier includes different intra-group identification information for each user terminal included in the terminal group. The controller determines, on the basis of the intra-group identification information included in the terminal identifier assigned to the user terminal, whether to perform transmission or to perform reception in the radio resource used for the D2D communication.

A communication control method according to the first embodiment to the third embodiment is used in a mobile communication system. The communication control method comprises: a step A of determining, by a user terminal included in a terminal group, an assignment pattern of a radio resource used for D2D communication that is direct device-to-device communication when the D2D communication is performed in the terminal group including a plurality of user terminals. In the step A, the user terminal determines, on the basis of a temporary identifier assigned from a network of the mobile communication system, the assignment pattern such that the radio resource used for the D2D communication is dispersed in a frequency direction and/or a time direction.

A processor according to the first embodiment to the third embodiment is provided in a user terminal used in a mobile communication system. The processor performed a process A of determining an assignment pattern of a radio resource used for D2D communication that is direct device-to-device communication when the D2D communication is performed in a terminal group including a plurality of user terminals. In the process A, the processor determines, on the basis of a temporary identifier assigned from a network of the mobile communication system, the assignment pattern such that the radio resource used for the D2D communication is dispersed in a frequency direction and/or a time direction.

A user terminal according to another embodiment is used in a mobile communication system. The user terminal comprises: a controller configured to determine, when D2D communication that is direct device-to-device communication is performed in a terminal group including a plurality of user terminals, an assignment pattern of a radio resource used for the D2D communication. The controller determines, on the basis of a subscriber identifier assigned to a user of the user terminal, the assignment pattern such that the radio resource used for the D2D communication is dispersed in a frequency direction and/or a time direction.

A mobile communication system according to the fourth embodiment is a mobile communication system that supports D2D proximity service which enables direct communication without passing through a network, and comprises: a user terminal selecting a small target region to be used for transmitting a D2D control signal from a plurality of small regions included in each of a plurality of D2D control resource regions provided periodically in a time axis direction, and the user terminal selects the small target region depending on a result of scanning the plurality of small regions.

In the fourth embodiment, each of the plurality of D2D control resource regions is a time-frequency resources used to transmit a discovery signal for discovery a proximity terminal, and the user terminal transmits the discovery signal as the D2D control signal by use of the small target region.

In the fourth embodiment, the user terminal preferentially selects a small region which is unused or where usage rate is low than a small region where the usage rate is high, as the small target region.

In the fourth embodiment, the user terminal calculates selection probability depending on the usage rate in regard to each of the plurality of small regions, and the user terminal selects the small target region on the basis of the selection probability.

In the fourth embodiment, the small target region is arranged at a same location in each of the plurality of D2D control resource regions.

In the fourth embodiment, the small target region is arranged at a different location from a location of a small target region of a previous period, depending on the location of the small target region of the previous period.

In the fourth embodiment, the small target region is arranged depending on a frame number of the small target region or a timestamp of the small target region.

In the fourth embodiment, the small target region includes a plurality of time-frequency resources, and the user terminal transmits the D2D control signal by use of one time-frequency resource of the plurality of time-frequency resources.

In the fourth embodiment, the user terminal reselects the small target region when the user terminal continuously and periodically transmits the D2D control signal and when a predetermined condition is satisfied.

In the fourth embodiment, the predetermined condition is a condition that elapsed time from selecting the small target region is greater than or equal to a threshold.

In the fourth embodiment, the predetermined condition is a condition that a distance between a current location of the user terminal and a point where the small target region is selected is greater than or equal to a threshold.

In the fourth embodiment, the predetermined condition is a condition that a change in usage rate of the plurality of small regions is greater than or equal to a threshold.

The mobile communication system according to the fourth embodiment comprises: another user terminal being capable of reception a D2D control signal transmitted by use of the small target region. The user terminal reselects the small target region when the user terminal receives, from the other user terminal, a collision notification indicating that the D2D control signal has collided after the D2D control signal transmitted by use of the small target region by the user terminal.

The mobile communication system according to the fourth embodiment comprises: another user terminal. The user terminal transmits collision information indicating that the D2D control signal has collided when the user terminal detects a collision of the D2D control signal transmitted by the other user terminal in response to scanning the plurality of small regions.

A user terminal according to the fourth embodiment is a user terminal used in a mobile communication system that supports D2D proximity service which enables direct communication without passing through a network, and the user terminal comprises: a controller configured to select a small target region to be used for transmitting a D2D control signal from a plurality of small regions included in each of a plurality of D2D control resource regions provided periodically in a time axis direction. The controller selects the small target region depending on a result of scanning the plurality of small regions.

### First Embodiment

Hereinafter, the present embodiment where the present invention is applied to an LTE system will be described.

(System Configuration)

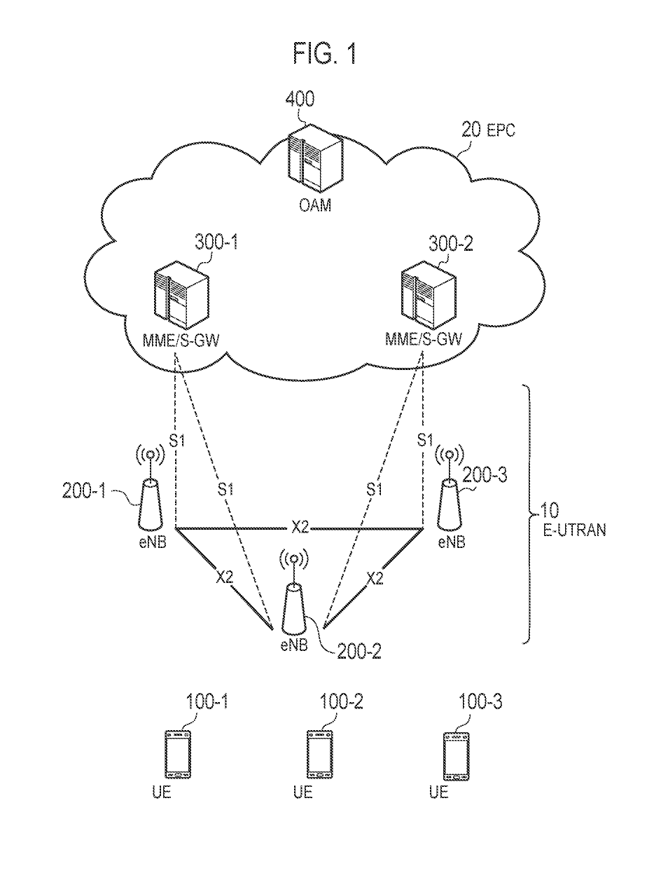

FIG. 1 is a configuration diagram of an LTE system according to the first embodiment. As shown in FIG. 1, the LTE system includes UEs (User Equipments) 100, E-UTRAN (Evolved Universal Terrestrial Radio Access Network) 10, and EPC (Evolved Packet Core) 20. The E-UTRAN 10 and the EPC 20 constitute a network.

The UE 100 corresponds to a user terminal. The UE 100 is a mobile communication device and performs radio communication with a connection cell (a serving cell). A configuration of the UE 100 will be described later.

The E-UTRAN 10 corresponds to a radio access network. The E-UTRAN 10 includes eNBs 200 (evolved Node-Bs). The eNB 200 corresponds to a base station. The eNBs 200 are connected mutually via an X2 interface. A configuration of eNB 200 will be described later.

The eNB 200 manages one cell or a plurality of cells and performs radio communication with the UE 100 that establishes a connection with the cell. The eNB 200 has a radio resource management (RRM) function, a routing function of user data, and a measurement control function for mobility control and scheduling and the like. The “cell” is used as a term indicating a minimum unit of a radio communication area, and is also used as a term indicating a function of performing radio communication with the UE 100.

The EPC 20 corresponds to a core network. The E-UTRAN 10 and the EPC 20 constitute a network of the LTE system. The EPC 20 includes MME (Mobility Management Entity)/S-GW (Serving-Gateway) 300 and OAM 400 (Operation and Maintenance). The MME is a network node that performs various mobility controls and the like, for the UE 100 and corresponds to a control station. The S-GW is a network node that performs control to transfer user data and corresponds to a mobile switching center. The MME/S-GW 300 is connected to the eNB 200 via an S1 interface. The OAM 400 is a server apparatus managed by an operator and performs maintenance and monitoring of the E-UTRAN 10.

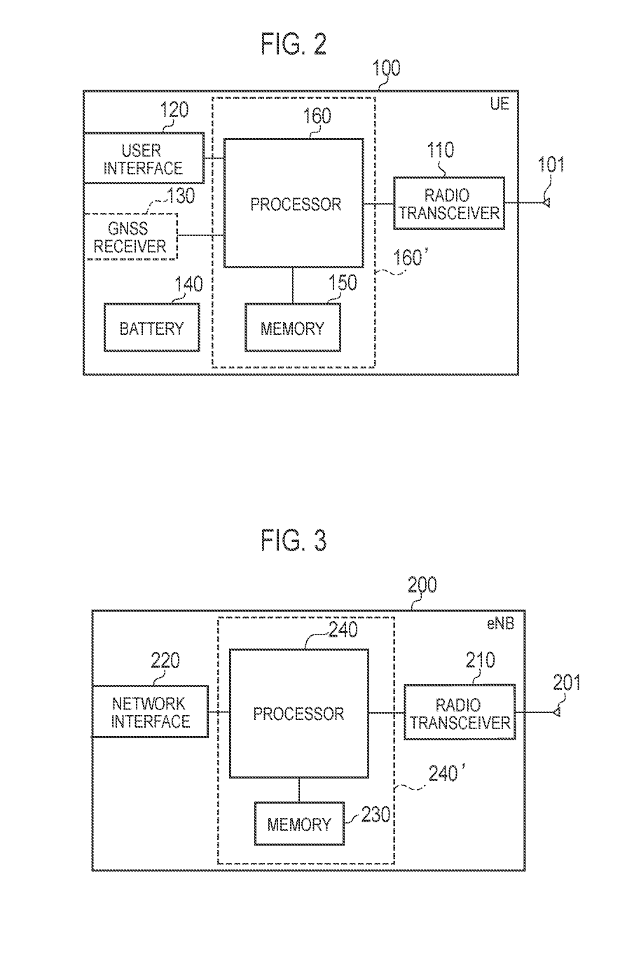

FIG. 2 is a block diagram of the UE 100. As shown in FIG. 2, the UE 100 includes an antenna 101, a radio transceiver 110, a user interface 120, GNSS (Global Navigation Satellite System) receiver 130, a battery 140, a memory 150, and a processor 160. The memory 150 and the processor 160 configure a controller. The UE 100 may not have the GNSS receiver 130. Furthermore, the memory 150 may be integrally formed with the processor 160, and this set (that is, a chip set) may be called a processor 160′ constituting a controller.

The antenna 101 and the radio transceiver 110 are used to transmit and receive a radio signal. The antenna 101 may include a plurality of antenna elements. The radio transceiver 110 converts a baseband signal (transmission signal) output from the processor 160 into the radio signal, and transmits the radio signal from the antenna 101. Furthermore, the radio transceiver 110 converts the radio signal received by the antenna 101 into the baseband signal (reception signal), and outputs the baseband signal to the processor 160.

The user interface 120 is an interface with a user carrying the UE 100, and includes, for example, a display, a microphone, a speaker, various buttons and the like. The user interface 120 receives an operation from a user and outputs a signal indicating the content of the operation to the processor 160. The GNSS receiver 130 receives a GNSS signal in order to obtain location information indicating a geographical location of the UE 100, and outputs the received signal to the processor 160. The battery 140 accumulates a power to be supplied to each block of the UE 100.

The memory 150 stores a program to be executed by the processor 160 and information to be used for a process by the processor 160. The processor 160 includes a baseband processor that performs modulation and demodulation, encoding and decoding and the like on the baseband signal, and a CPU (Central Processing Unit) that performs various processes by executing the program stored in the memory 150. The processor 160 may further include a codec that performs encoding and decoding on sound and video signals. The processor 160 executes various processes and various communication protocols described later.

FIG. 3 is a block diagram of the eNB 200. As shown in FIG. 3, the eNB 200 includes an antenna 201, a radio transceiver 210, a network interface 220, a memory 230, and a processor 240. The memory 230 and the processor 240 constitute a controller. In addition, the memory 230 is integrated with the processor 240, and this set (that is, a chipset) may be called a processor 240′ constituting a controller.

The antenna 201 and the radio transceiver 210 are used to transmit and receive a radio signal. The radio transceiver 210 converts the baseband signal (transmission signal) output from the processor 240 into the radio signal, and transmits the radio signal from the antenna 201. Furthermore, the radio transceiver 210 converts the radio signal received by the antenna 201 into the baseband signal (reception signal), and outputs the baseband signal to the processor 240.

The network interface 220 is connected to the neighboring eNB 200 via the X2 interface and is connected to the MME/S-GW 300 via the S1 interface. The network interface 220 is used in communication performed on the X2 interface and communication performed on the S1 interface.

The memory 230 stores a program to be executed by the processor 240 and information to be used for a process by the processor 240. The processor 240 includes the baseband processor that performs modulation and demodulation, encoding and decoding and the like on the baseband signal and a CPU that performs various processes by executing the program stored in the memory 230. The processor 240 executes various processes and various communication protocols described later.

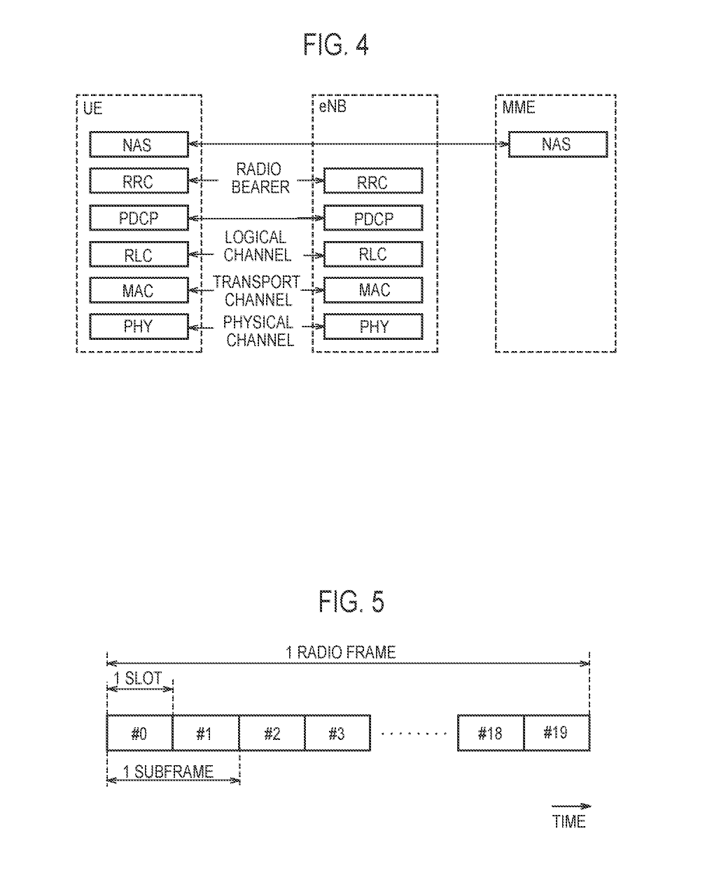

FIG. 4 is a protocol stack diagram of a radio interface in the LTE system. As shown in FIG. 4, the radio interface protocol is classified into a layer 1 to a layer 3 of an OSI reference model, wherein the layer 1 is a physical (PHY) layer. The layer 2 includes MAC (Medium Access Control) layer, RLC (Radio Link Control) layer, and PDCP (Packet Data Convergence Protocol) layer. The layer 3 includes RRC (Radio Resource Control) layer.

The PHY layer performs encoding and decoding, modulation and demodulation, antenna mapping and demapping, and resource mapping and demapping. The PHY layer provides a transmission service to an upper layer by using a physical channel. Between the PHY layer of the UE 100 and the PHY layer of the eNB 200, user data and a control signal are transmitted through the physical channel.

The MAC layer performs priority control of data, and a retransmission process and the like by hybrid ARQ (HARQ). Between the MAC layer of the UE 100 and the MAC layer of the eNB 200, data and a control signal are transmitted via a transport channel. The MAC layer of the eNB 200 includes a scheduler (a MAC scheduler) decides (schedules) a transport format of an uplink and a downlink (a transport block size, a modulation and coding scheme) and a resource block to be assigned to the UE 100.

The RLC layer transmits data to an RLC layer of a reception side by using the functions of the MAC layer and the PHY layer. Between the RLC layer of the UE 100 and the RLC layer of the eNB 200, data and a control signal are transmitted via a logical channel.

The PDCP layer performs header compression and decompression, and encryption and decryption.

The RRC layer is defined only in a control plane handling with a control signal. Between the RRC layer of the UE 100 and the RRC layer of the eNB 200, a control signal (an RRC message) for various types of setting is transmitted. The RRC layer controls the logical channel, the transport channel, and the physical channel in response to establishment, re-establishment, and release of a radio bearer. When a connection (an RRC connection) is between the RRC of the UE 100 and the RRC of the eNB 200, the UE 100 is in a connected state (RRC connected state). Otherwise, the UE 100 is in an idle state (RRC idle state).

NAS (Non-Access Stratum) layer positioned above the RRC layer performs session management, mobility management and the like.

FIG. 5 is a configuration diagram of a radio frame used in the LTE system. In the LTE system, OFDMA (Orthogonal Frequency Division Multiple Access) is employed in a downlink (DL), and SC-FDMA (Single Carrier Frequency Division Multiple Access) is employed in an uplink (UL), respectively.

As shown in FIG. 5, the radio frame is configured by 10 subframes arranged in a time direction, wherein each subframe is configured by two slots arranged in the time direction. Each subframe has a length of 1 ms and each slot has a length of 0.5 ms. Each subframe includes a plurality of resource blocks (RBs) in a frequency direction, and a plurality of symbols in the time direction. Each resource block includes a plurality of subcarriers in the frequency direction. A radio resource unit configured by one subcarrier and one symbol is called a resource element (RE). Each symbol is provided at a head thereof with a guard interval called a cyclic prefix (CP).

Among radio resources assigned to the UE 100, a frequency resource is configured by a resource block and a time resource is configured by a subframe (or slot).

In the downlink, an interval of several symbols at the head of each subframe is a region mainly used as a physical downlink control channel (PDCCH) for transmitting downlink communication signal. Furthermore, the remaining portion of each subframe is a region that can be mainly used as a physical downlink shared channel (PDSCH) for transmitting downlink user data. Moreover, in each subframe, cell-specific reference signals (CRSs) are distributed and arranged.

In the uplink, both ends of each subframe in the frequency direction are control regions mainly used as a physical uplink control channel (PUCCH) for transmitting an uplink control signal. Furthermore, the center portion of each subframe in the frequency direction is a region that can be mainly used as a physical uplink shared channel (PUSCH) for transmitting an uplink user data. Moreover, in each subframe, a demodulation reference signal (DMRS) and a sounding reference signal (SRS) are arranged.

(D2D Communication)

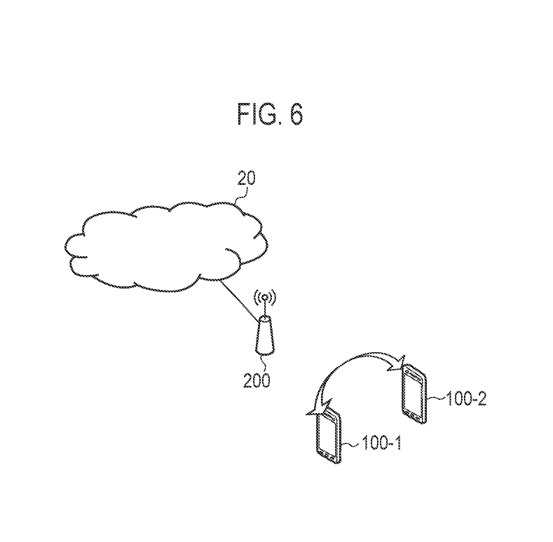

An LTE system according to the first embodiment supports D2D communication that is direct device-to-device communication (UE-to-UE communication). FIG. 6 is a diagram for illustrating D2D communication according to the first embodiment.

Hereinafter, the D2D communication is described in comparison with cellular communication that is normal communication of the LTE system. The cellular communication is a communication mode in which a data path pass through a network (E-UTRAN 10 and EPC 20). The data path is a transmission path for user data.

On the other hand, as illustrated in FIG. 6, the D2D communication is a communication mode in which a data path set between UEs does not pass through the network. A plurality of UEs 100 (UE 100-1 and UE 100-2) adjacent to each other directly perform radio communication with low transmission power in a cell of the eNB 200.

In this manner, the plurality of adjacent UEs 100 directly perform radio communication with low transmission power, and thus it is possible to reduce a power consumption of the UE 100 and to reduce interference to a neighboring cell in comparison with the cellular communication.

In the following, an overview of the D2D communication will be described in detail.

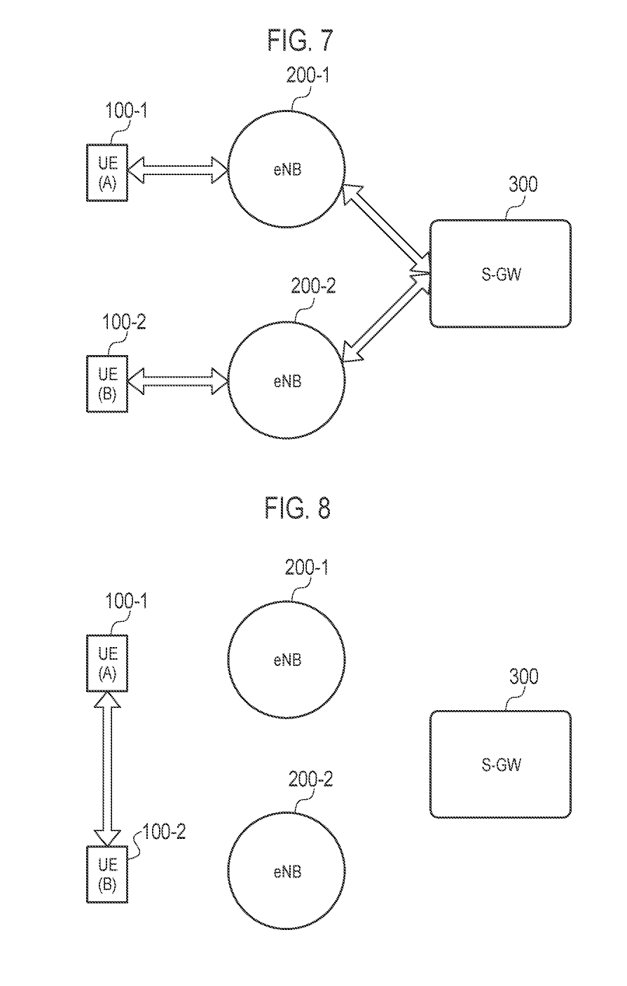

FIG. 7 is a diagram showing a data path in the cellular communication. In this case, FIG. 7 illustrates the case in which the cellular communication is performed between UE 100-1 that establishes a connection with eNB 200-1 and UE 100-2 that establishes a connection with eNB 200-2.

As shown in FIG. 7, the data path of the cellular communication passes through the network. Specifically, the data path is set to pass through the eNB 200-1, the S-GW 300, and the eNB 200-2.

FIG. 8 is a diagram showing a data path in the D2D communication. In this case, FIG. 8 illustrates the case in which the D2D communication is performed between the UE 100-1 that establishes a connection with the eNB 200-1 and the UE 100-2 that establishes a connection with the eNB 200-2.

As shown in FIG. 8, the data path of the D2D communication does not pass through the network. That is, direct radio communication is performed between the UEs. As described above, when the UE 100-2 exists in the proximity of the UE 100-1, the D2D communication is performed between the UE 100-1 and the UE 100-2, thereby obtaining an effect that a traffic load on the network and a battery consumption amount of the UE 100 are reduced, for example.

It is noted that there are a case (a) that the D2D communication starts after a proximity terminal is discovered by performing an operation for discovery of a proximity terminal and a case (b) that the D2D communication starts without the operation for discovery of a proximity terminal, as a case of the D2D communication starting.

In the case (a), for example, the UE 100 being one of the UE 100-1 and the UE 100-2 discoveries the other UE 100 existing in the proximity of the UE 100, and then the D2D communication starts.

In this case, the UE 100 has a (Discover) function of discovering the other UE 100 existing in the proximity of the UE 100 and/or a (Discoverable) function of being discovered by the other UE 100.

Specifically, the UE 100-1 transmits a discovery signal (Discovery signal) used for discovering a proximity terminal or for being discovered by a proximity terminal. The UE 100-2 receiving the discovery signal discoveries the UE 100-1. The UE 100-2 transmits a response to the discovery signal, and then the UE 100-1 transmitting the discovery signal discoveries the UE 100-2 being the proximity terminal.

Also, it is not necessary for the UE 100 to perform the D2D communication even though the UE 100 discoveries the proximity terminal. For example, the UE 100-1 and the UE 100-2 negotiate after the discovery of each other, and then the UE 100-1 and the UE 100-2 determine whether to perform the D2D communication. The D2D communication starts when each of the UE 100-1 and the UE 100-2 agrees with performing the D2D communication. Furthermore, the UE 100-1 may report a discovery of the UE 100 (that is, UE 100-2) in proximity to an upper layer (for instance, an application or the like) when the UE 100-1 does not perform the D2D communication after the discovery of the proximity terminal. For example, the application enables to perform a process (for instance, a process in which a location of the UE 100-2 is plotted in map information) on the basis of the report.

Furthermore, the UE 100 reports the discovery of the proximity terminal to the eNB 200, and then the UE 100 is able to receive an instruction of whether the UE 100 communicates with the proximity terminal by the cellular communication or the D2D communication, from the eNB 200.

On the other hand, in the case (b), for example, the UE 100-1 starts transmitting (informing, by broadcast or the like, of) a signal for the D2D communication without identifying the proximity terminal. Thus, the UE 100 can start the D2D communication regardless of whether to discover the proximity terminal. Furthermore, the UE 100-2 being performing a waiting operation for a signal for the D2D communication synchronizes and/or performs demonstration on the basis of the signal from the UE 100-1.

(Operation According to First Embodiment)

Next, an operation according to the first embodiment will be described.

(1) Operation Overview

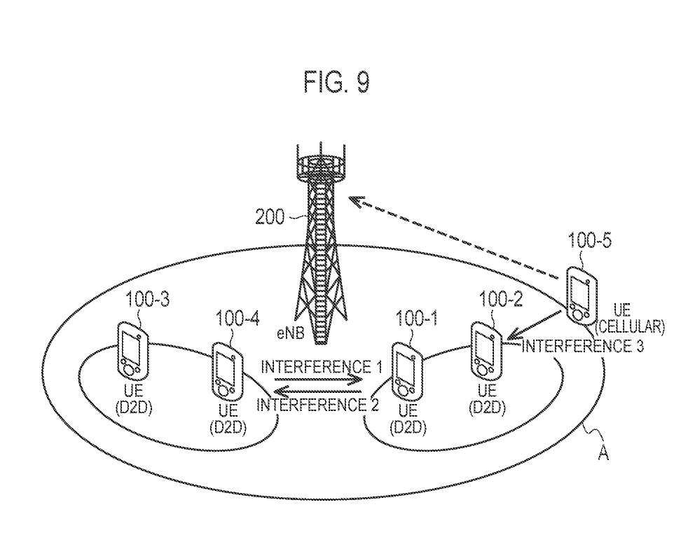

FIG. 9 is a diagram for describing an operation environment according to the first embodiment.

As shown in FIG. 9, a UE 100-1 to a UE 100-5 exist in a cell managed by the eNB 200. A D2D group including the UE 100-1 and the UE 100-2 (hereinafter, referred to as “D2D group 1”) mutually performs D2D communication. A D2D group including the UE 100-3 and the UE 100-4 (hereinafter, referred to as “D2D group 2”) mutually performs D2D communication. A D2D group corresponds to a terminal group. The UE 100-5 performs cellular communication with the eNB 200 in an edge (cell edge) of a coverage area A of the cell managed by the eNB 200.

In terms of reducing a load on a network, a UE-led scheduling is preferable, by which an assignment of a radio resource used for D2D communication is performed under the initiative of the UE 100. For example, a UE 100 included in a D2D group determines a radio resource used for D2D communication, and the determined radio resource is used for D2D communication in the D2D group.

However, in the UE-led scheduling, a radio resource used for D2D communication in the D2D group may coincide with a radio resource used for cellular communication or a radio resource used for D2D communication in another D2D group.

An example in FIG. 9 shows that when a radio resource used for D2D communication in the D2D group 1 coincides with a radio resource used for D2D communication in the D2D group 2, interference between D2D groups (interference 1 and interference 2) occurs. Further, when the radio resource used for D2D communication in the D2D group 1 coincides with a radio resource used for uplink communication in the UE 100-5, interference from cellular communication to D2D communication (interference 3) occurs. When such a situation continues where radio resources coincide with each other, D2D communication may become disabled due to the interference.

When D2D communication, direct device-to-device communication, is performed in a D2D group including a plurality of UEs 100, the UE 100 according to the first embodiment determines an assignment pattern of a radio resource used for the D2D communication (hereinafter, referred to as “D2D resource assignment pattern”). The UE 100 determines, on the basis of a temporary identifier assigned from a network, a D2D resource assignment pattern such that the radio resource used for the D2D communication is dispersed in the frequency direction and/or the time direction.

Thus, even when the UE-led scheduling is performed, it is possible to reduce a probability of continuing a situation where a radio resource used for D2D communication in a D2D group coincides with a radio resource used for cellular communication or a radio resource used for D2D communication in another D2D group. Therefore, it is possible to prevent D2D communication from becoming disabled due to interference.

In the first embodiment, the temporary identifier is a D2D-RNTI (D2D-Radio Network Temporary Identifier) for identifying a D2D group. The D2D-RNTI corresponds to a group identifier. The UE 100 determines, on the basis of a D2D-RNTI assigned from the network, a D2D resource assignment pattern such that a radio resource used for D2D communication is dispersed in the frequency direction and/or the time direction. The D2D-RNTI is a common identifier among each UE 100 included in the D2D group and is shared with each UE 100 included in the D2D group. The D2D-RNTI may be used for a purpose of other than determining a D2D resource assignment pattern, for example, a purpose of simultaneously transmitting, from the eNB 200, the control signal to each UE 100 included in the D2D group.

Alternatively, the temporary identifier is a C-RNTI (Cell-Radio Network Temporary Identifier) for identifying each UE 100 within a cell. The C-RNTI corresponds to the terminal identifier. The UE 100 determines, on the basis of a C-RNTI assigned to a representative UE 100 included in a D2D group, the D2D resource assignment pattern such that a radio resource used for D2D communication is dispersed in the frequency direction and/or the time direction. As for the representative UE, when a UE 100 having a capability of becoming a representative acts as a trigger and forms a group with a surrounding UE 100, for example, it may be possible to consider a method that the UE 100 acting as a trigger becomes the representative UE. Alternatively, when some UEs 100 within the group are out of a coverage of the eNB 200, it is desirable to select a representative from UEs 100 within the coverage of the eNB 200. Alternatively, the representative UE may be determined (registered) in advance by the network, or the network may select an appropriate UE 100 from UEs 100 having a capability of becoming a representative, on the basis of capability information (Capability bit) transmitted from the UE 100 to the network. It is noted that the C-RNTI is used for a purpose of other than determining the D2D resource assignment pattern, for example, a purpose of individually transmitting, from the eNB 200, the control signal to each UE 100 included in the D2D group. Moreover, in addition to a case where the UE 100 determines the D2D resource assignment pattern on the basis of the C-RNTI assigned to the representative UE 100, the UE 100 may determine the D2D resource assignment pattern on the basis of the C-RNTI of each UE 100 included in the D2D group. In this case, a C-RNTI of each UE 100 included in the D2D group needs to be shared within the D2D group.

As described above, when determining the D2D resource assignment pattern on the basis of the D2D-RNTI or the C-RNTI (hereinafter, these are generally referred to as “RNTI,” where appropriate), it is possible to minimize the control signal to be transmitted from the network to the UE 100 included in the D2D group.

(2) Operation Sequence

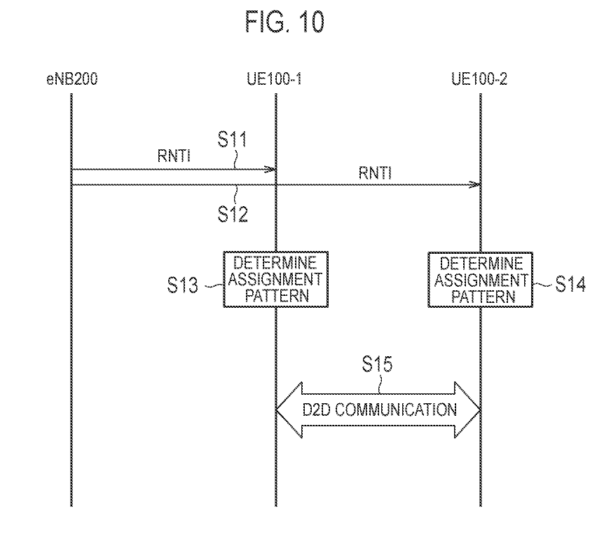

FIG. 10 is an operation sequence chart according to the first embodiment. The UE 100-1 and the UE 100-2 configure the D2D group 1.

As shown in FIG. 10, in step S11, the eNB 200 transmits an RNTI to the UE 100-1. The UE 100-1 that has received the RNTI stores the RNTI. In step S12, the eNB 200 transmits an RNTI to the UE 100-2. The UE 100-2 that has received the RNTI stores the RNTI.

When the C-RNTI is used for determining a D2D resource assignment pattern, in order for the C-RNTI assigned to either one UE 100 (representative UE) of the UE 100-1 and the UE 100-2 to be notified to the other UE 100, negotiation may be performed in the UE 100-1 and the UE 100-2 by using a predetermined radio resource or a radio resource designated by the eNB 200.

In step S13, the UE 100-1 determines the D2D resource assignment pattern on the basis of an RNTI that is shared with the UE 100-2. Further, in step S14, the UE 100-2 determines the D2D resource assignment pattern on the basis of an RNTI that is shared with the UE 100-1. The UE 100-1 and the UE 100-2 determine the D2D resource assignment pattern by a previously defined determination method (determination algorithm). Details of such a determination method will be described later.

In step S15, the UE 100-1 and the UE 100-2 perform D2D communication by using a radio resource assigned in accordance with the D2D resource assignment pattern. It is noted that basically, after the D2D resource assignment pattern is determined (set), a transmission-side performs transmission when the transmission-side wants to, and a reception-side tries to perform reception in every set radio resources or performs operation of verifying the presence or absence of data. “Verifying the presence or absence of data” is to verify the presence or absence of data by trying to receive the control channel, when the control channel is also transmitted by a radio resource set by the D2D resource assignment pattern, for example.

In the present sequence, the D2D resource assignment pattern is determined in each of the UE 100-1 and the UE 100-2; however, only one of the UEs 100 (representative UE) may determine the D2D resource assignment pattern. In this case, the representative UE may notify the other UE 100 of the D2D resource assignment pattern by using a predetermined radio resource or a radio resource designated by the eNB 200.

(3) Method of Determining Assignment Pattern

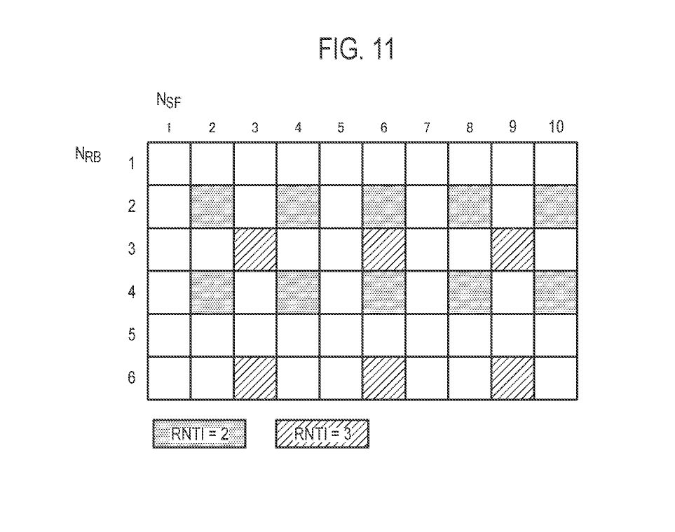

FIG. 11 is a diagram for describing a method of determining a D2D resource assignment pattern according to the first embodiment.

As shown in FIG. 11, for the frequency direction, the UE 100 determines a resource block (frequency resource) used for D2D communication by a resource block number (NRB) and the RNTI. The UE 100 uses, for example, a resource block of the resource block number (NRB) which satisfies “NRB mod RNTI=0” for D2D communication. However, in a case where the range of a resource block (frequency band) available for D2D communication is limited, a resource block used for D2D communication is determined within the limited range.

For the time direction, the UE 100 determines a subframe (time resource) used for D2D communication by a subframe number (NSF) and an RNTI. The UE 100 uses, for example, a subframe of the subframe number (NSF) which satisfies “NSF mod RNTI=0” for D2D communication. It is noted that assignment may be performed by a radio frame unit (system frame unit) instead of a subframe unit. In this case, instead of the subframe number (NSF), a radio frame number (system frame number) is used.

FIG. 11 shows a D2D resource assignment pattern in a case where the above-described determination method is applied to “RNTI=2” and “RNTI=3” in both the frequency direction and the time direction.

In a case where “RNTI=2,” resource block numbers (NRBs) of the resource block used for D2D communication are, for example, “2,” “4,” (and “6”), and subframe numbers (NSFs) of the subframe used for D2D communication are, for example, “2,” “4,” “6,” “8,” and “10.”

On the other hand, in a case where “RNTI=3,” resource block numbers (NRBs) of the resource block used for D2D communication are, for example, “3” and “6,” and subframe numbers (NSFs) of the subframe used for D2D communication are, for example, “3,” “6,” and “9.”

It is noted that “RNTI mod NRB=0” and “RNTI mod NSF=0” may be applied, instead of “NRB mod RNTI=0” and “NSF mod RNTI=0.” Further, in order to further randomize the D2D resource assignment pattern, the remaining values may be changed (for example, offset may be applied) for each D2D group, or an offset value may be incremented for each subframe. In addition, an RNTI used for calculation may be repeated at a certain upper limit number. For example, not the RNTI assigned from the network is used as is for calculation, but a value obtained by “RNTI mod n” may be used for calculation.

(Summary of First Embodiment)

The UE 100 according to the first embodiment determines, on the basis of the temporary identifier (RNTI) assigned from the network, the D2D resource assignment pattern such that a radio resource used for D2D communication is dispersed in the frequency direction and/or the time direction. Thus, even when the UE-led scheduling is performed, it is possible to reduce a probability of continuing a situation where a radio resource used for D2D communication in a D2D group coincides with a radio resource used for cellular communication or a radio resource used for D2D communication in another D2D group. Therefore, it is possible to prevent D2D communication from becoming disabled due to interference.

[Modification of First Embodiment]

Instead of the above-described method of determining an assignment pattern, the D2D resource assignment pattern may be determined by generating a pseudo random number sequence with the RNTI as a random number seed.

For example, a resource block and/or a subframe corresponding to a value included in the pseudo random number sequence (pseudo random number output) is used for D2D communication. When the D2D-RNTI is used, the D2D-RNTI can be used as is. When the C-RNTI is used and when there are two C-RNTIs (C-RNTI1, C-RNTI2) of the transmission-side and the reception-side, the random number seed may be regarded as a value obtained by “C-RNTI1 mod C-RNTI2.”

Further, the D2D group is notified of a threshold value from the network, and only a resource block and/or a subframe corresponding to a value exceeding the threshold value in the pseudo random number sequence with the RNTI as a random number seed (pseudo random number output) may be used for D2D communication. In this case, the network is capable of adjusting transmission frequency in D2D communication by adjusting the threshold value. The threshold value may be notified by broadcast using system information or by unicast using an dedicated RRC message. In case of the unicast, the network is capable of setting different threshold values for each D2D group.

### Second Embodiment

A second embodiment will be described while focusing on the differences from the first embodiment. The second embodiment is similar to the first embodiment in regard to the system configuration.

In the above-described first embodiment, a method of determining a transmission-side UE and a reception-side UE in D2D communication is not particularly mentioned; however, in the second embodiment, the method of determining a transmission-side UE and a reception-side UE in D2D communication, will be described.

(Operation According to Second Embodiment)

In the second embodiment, the RNTI includes different intra-group identification information for each UE 100 included in the D2D group. The UE 100 determines, on the basis of the intra-group identification information included in the RNTI assigned to the UE 100 itself, whether to perform transmission or to perform reception in a radio resource used for D2D communication. A case where the D2D-RNTI is used as the above RNTI and a case where the C-RNTI is used as the above RNTI will be respectively described, below.

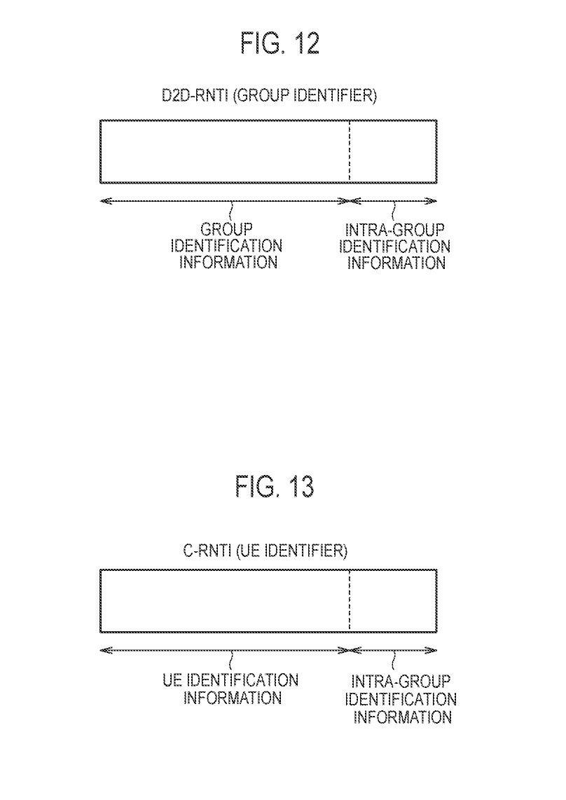

FIG. 12 is a diagram for describing the D2D-RNTI according to the second embodiment. As shown in FIG. 12, low-order several bits (for example, low-order 4 bits) of the D2D-RNTI are set as the intra-group identification information. For example, in a case where 003D-FFF3 is assignable as the D2D-RNTI, the network sets high-order 12 bits (003x-FFFx) as group identification information (D2D group ID) and low-order 4 bits (xxx0-xxxF) as the intra-group identification information, and individually assigns the same to the UE 100 included in the D2D group. The network assigns different intra-group identification information for each UE 100 included in the D2D group. It is noted that the number of bits of the group ID and/or intra-group ID may be notified or broadcasted to the UE 100 from the network or may be the number of bits that is previously decided.

By MOD operation of intra-group identification information (IDD2DUE) assigned to the UE 100 itself and a D2D subframe number (SFD2D), each UE 100 included in the D2D group determines whether to perform transmission or to perform reception in the subframe. For example, when “SFD2D mod IDD2DUE=0” is satisfied, the UE 100 performs transmission as the transmission-side UE. Otherwise, the UE 100 performs reception as the reception-side UE.

The D2D subframe number (SFD2D) is determined by “SFD2D=SFsystem mod IDD2DUE_max.” Here, “SFsystem” is a system subframe number. “IDD2DUE_max” is the maximum number of the intra-group identification information (IDD2DUE) of the D2D group (that is, the number of UEs within the D2D group), and is notified from the network by RRC message, etc.

FIG. 13 is a diagram for describing the C-RNTI according to the second embodiment. As shown in FIG. 13, low-order several bits (for example, low-order 4 bits) of the C-RNTI are set as the intra-group identification information (IDD2DUE). The network assigns different intra-group identification information for each UE 100 included in the D2D group.

For the intra-group identification information (IDD2DUE), a rule to assign the intra-group identification information with an increment from 1 (such as, 1, 2, . . . ) is desirable; however, a rule other than the rule may be applied for transmission randomization in the time direction.

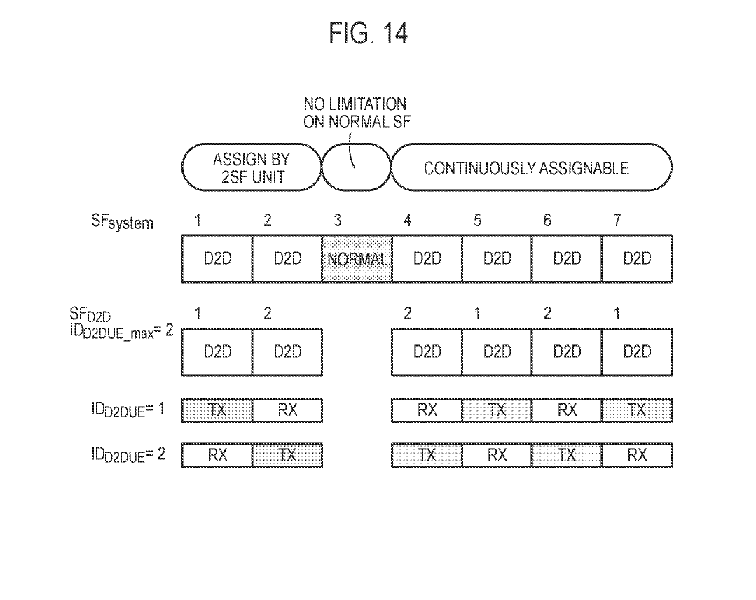

FIG. 14 is a diagram for describing a specific example of D2D-transmission-and-reception assignment according to the second embodiment.

As shown in FIG. 14, D2D communication is performed in a D2D group including a UE 100 to which “1” is assigned as the intra-group identification information (IDD2DUE) and a UE 100 to which “2” is assigned as the intra-group identification information (IDD2DUE). In this case, “IDD2DUE_max” indicating the number of UEs within the D2D group is “2.”

Subframes with the system subframe number (SFsystem) “1,” “2” are continuously assigned as a subframe used for D2D communication. A subframe with the system subframe number (SFsystem) “1” has the D2D subframe number (SFD2D) “1,” and the UE 100 to which “1” is assigned as the intra-group identification information (IDD2DUE) becomes the transmission-side UE. Further, a subframe with the system subframe number (SFsystem) “2” has the D2D subframe number (SFD2D) “2,” and the UE 100 to which “2” is assigned as the intra-group identification information (IDD2DUE) becomes the transmission-side UE. Further, subframes of the system subframe number (SFsystem) “4,” “5,” “6,” “7” are continuously assigned as the subframe used for D2D communication.

It is noted that in the second embodiment, D2D-transmission-and-reception assignment by a subframe unit is described; however assignment by a slot unit, not by a subframe unit, may be performed.

(Summary of Second Embodiment)

In the second embodiment, the RNTI includes different intra-group identification information for each UE 100 included in the D2D group. The UE 100 determines, on the basis of the intra-group identification information included in the RNTI assigned to the UE 100 itself, whether to perform transmission or to perform reception in a radio resource used for D2D communication. Therefore, it is possible to appropriately determine the transmission-side UE and the reception-side UE in D2D communication.

### Third Embodiment

A third embodiment will be described while focusing on the differences from the first embodiment and the second embodiment. The third embodiment is similar to the first embodiment in regard to the system configuration.

In the above-described first and second embodiments, details of the D2D group is not particularly mentioned; however, in the third embodiment, details of the D2D group will be described.

The D2D group is a group including a plurality of UEs 100 between which inter-UE synchronization is performed. Hereinafter, such a D2D group is referred to as a “cluster.” One cluster is composed of a plurality of UEs 100 which synchronize with a cluster head that is the center of the synchronization. In this case, a D2D-RNTI for identifying a cluster is assigned from the network to the cluster, therefore, the UE 100 may determine a D2D resource assignment pattern on the basis of such a D2D-RNTI.

Alternatively, the D2D group is a group including a plurality of UEs 100 between which inter-UE synchronization is performed and which transmit and receive data through D2D communication. Hereinafter, such a D2D group is referred to as a “communication group.” The communication group is a set of arbitrary UEs within a cluster and is a set of transmission/reception UEs that transmit and receive user data. In this case, a D2D-RNTI for identifying the communication group is assigned from the network to the communication group, therefore, the UE 100 may determine a D2D resource assignment pattern on the basis of such a D2D-RNTI.

In addition, a plurality of data distribution systems are defined as a data distribution system for transmitting and receiving data (user data) through D2D communication. The plurality of data distribution systems are at least two of unicast (one-to-one) distribution, group cast (one-to-specified large number) distribution, and broadcast (one-to-unspecified large number) distribution. The communication group is set for each data distribution system. In this case, a D2D-RNTI is assigned, from the network, to each of a communication group performing the unicast distribution and a communication group performing the group cast distribution, therefore, the UE 100 may determine a D2D resource assignment pattern on the basis of such a D2D-RNTI.

Here, when the UE 100 belongs to a plurality of communication groups set by each data distribution system, a plurality of D2D-RNTIs corresponding to the plurality of communication groups are assigned to the UE 100. The UE 100 determines a D2D resource assignment pattern for each of the plurality of communication groups on the basis of the plurality of D2D-RNTIs. Therefore, the UE 100 is capable of determining different D2D resource assignment patterns for each communication group on the basis of the D2D-RNTI of each communication group. Specifically, as described in the first embodiment, the D2D resource assignment pattern is determined such that a radio resource used for D2D communication is dispersed in the frequency direction and/or the time direction.

### Fourth Embodiment

A forth embodiment will be described while focusing on the differences from the first to third embodiments. In the first to third embodiments, determining a D2D resource assignment pattern on the basis of a temporary identifier assigned from the network prevents D2D communication from becoming disabled due to interference. On the other hand, in the fourth embodiment, selecting a radio resource (target small region) used for transmitting a D2D communication-use control signal depending on a result of scanning a radio resource used for D2D communication prevents D2D communication from becoming disabled due to interference. Details will be described, below.

In 3GPP (3rd Generation Partnership Project) which is a project aiming to standardize a mobile communication system, the introduction of a Device to Device (D2D) proximity service is discussed as a new function in Release 12 and later.

The D2D proximity service (D2D ProSe) is a service enabling direct communication without passing through a network within a synchronization cluster including a plurality of synchronized user terminals. The D2D proximity service includes a discovery process (Discovery) for discovering a proximal terminal and a communication process (Communication) in which direct communication is performed.

Incidentally, the UE transmits a discovery signal used for discovering a proximal UE. Further, when the UE determines a time-frequency resource (hereinafter, referred to as data resource, where appropriate) used for transmitting D2D communication data, it is supposed that in order to inform surrounding UEs of the determined data resource, the UE transmits a control signal indicating a position of the determined data resource (that is, SA: Scheduling Assignment).

Here, it is assumed that the UE randomly selects a time-frequency resource for transmitting such a D2D control signal. In this case, when the UE and another UE select the same time-frequency resource, it is probable that D2D control signals transmitted by each of the UE and the other UE collide with each other. That is, in the UE-led scheduling, a radio resource used for D2D communication by the UE may coincide with a radio resource used for D2D communication by the other UE. As a result, it may not be possible to receive the D2D control signal.

By using FIG. 9 as an example, a radio resource used for transmitting a D2D control signal from the UE 100-1 and a radio resource used for transmitting a D2D control signal from the UE 100-4 may coincide with each other, for example. When such a situation continues where radio resources coincide with each other, D2D communication may become disabled due to the interference.

Therefore, in the fourth embodiment, the UE 100 selects a target small region used for transmitting a D2D control signal depending on a result of scanning a plurality of small regions included in each of a plurality of D2D control resource regions that are periodically provided in the time direction. In this way, even when the UE-led scheduling is performed, the UE 100 is capable of recognizing whether or not the other UE 100 transmits a discovery signal according to the scanning result, and thus, it is possible to reduce collision of the discovery signal. As a result, it is possible to prevent D2D communication from becoming disabled due to interference.

A case in which the UE 100 according to the fourth embodiment uses a radio resource (time-frequency resource) in a Discovery region for a discovery signal to transmit a discovery signal, will be described, below.

(Operation of the UE 100 According to Fourth Embodiment)

Next, an operation of the UE 100 according to the embodiment will be described. It is noted that different parts from other operation will be mainly described and that the description about the same parts is omitted as necessary.

(1) Selection of Small Target Region

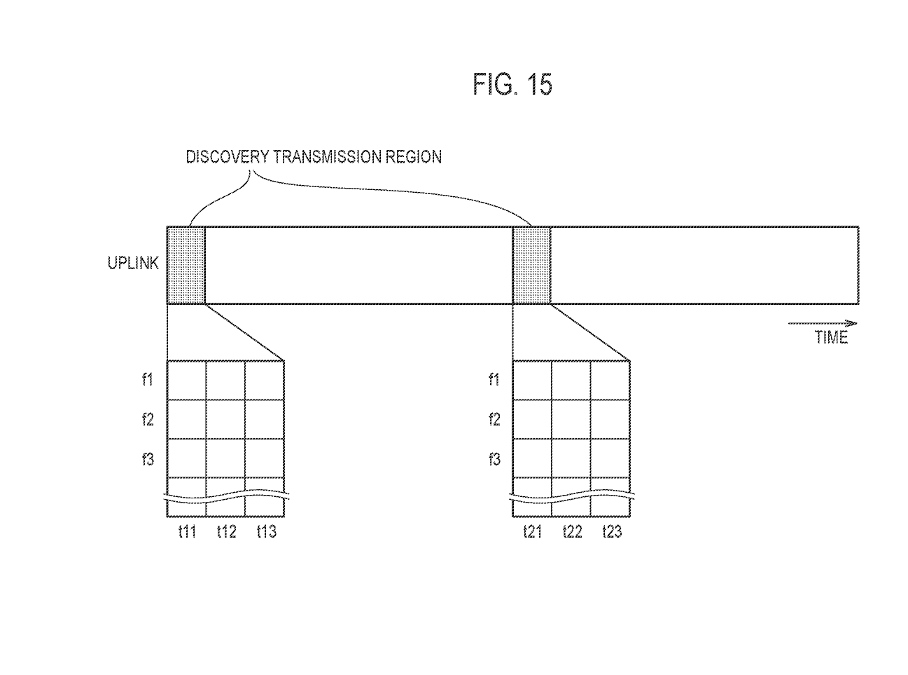

The selection of the small target region is described by use of FIG. 15 to FIG. 22. FIG. 15 is a configuration diagram of a radio frame in the mobile communication system according to the present embodiment.

As shown in FIG. 15, a plurality of Discovery regions are provided periodically in a time axis direction. For example, the Discovery regions are provided with a period of 1 [s]. The Discovery regions are time-frequency resources to be used for transmitting the discovery signal.

The UE 100 divides the Discovery region into a plurality of small regions. The UE 100 scans the Discovery region (the plurality of small regions). A small target region is selected depending on a result of scanning the plurality of small regions. The UE 100 transmits the discovery signal by use of the small target region. Basically, the UE 100 (continuously) transmits the discovery signal by use of the selected small target region where the UE 100 continuously and periodically transmits the discovery signal.

It is possible to reduce a collision of the discovery signals because the UE 100 recognizes whether other UE 100 transmits the discovery signal by the result of the scan.

Furthermore, each of a size of the small region and an allocation interval in the Discovery regions (a period of the Discovery regions) may be a pre-configured value (Pre-config. value) or may change depending on at least one of the cell, a location of the UE 100, time and change of the number of the UE existing in the cell.

An operation example of the UE 100 (UE 1 to UE 5) relevant to the selection of the small target region will be described below.

(A) Operation Example 1-1

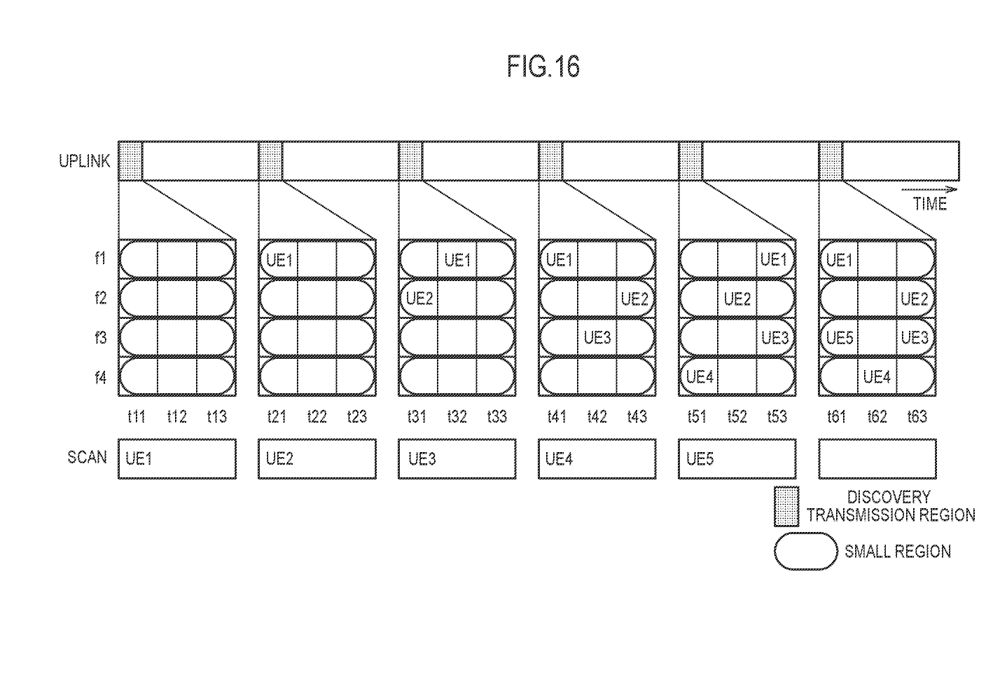

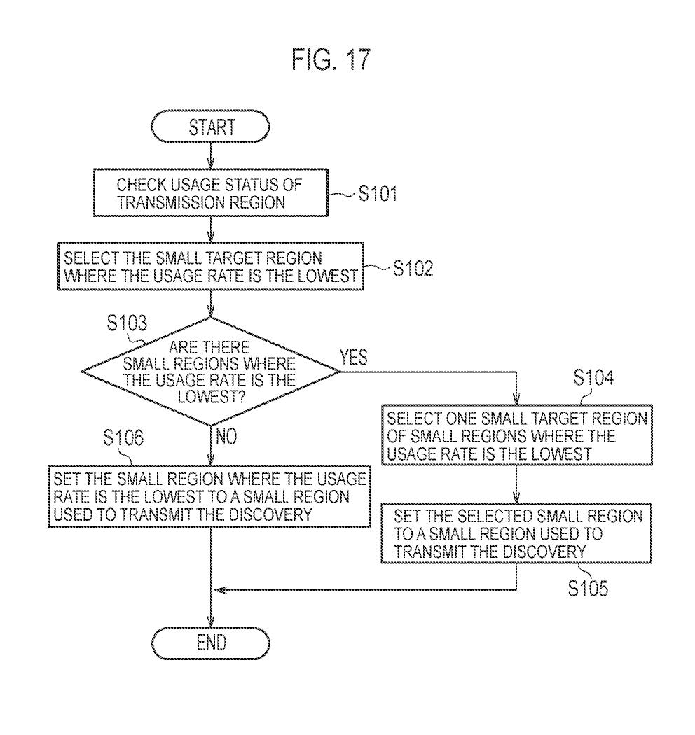

The operation example 1-1 will be described below by use of FIG. 16 and FIG. 17. FIG. 16 is an explanation diagram for explaining the operation example 1-1. FIG. 17 is a flowchart for explaining one example of the operation example 1-1.

In the operation example 1-1, the Discovery region is divided corresponding to each of frequency bands f1, f2, f3 and f4, and then the Discovery region is divided into four small regions. The small regions include 3 time-frequency resources (for example, t11, t12, and t13) depending on time. A location of each small region does not change depending on time and each small region is arranged at a location corresponding to a location of each small region of a previous period.

Firstly, in t1x, an UE 1 scans the Discovery region, and then the UE 1 checks usage status of the Discovery region (the plurality of small regions). The UE 1 detects that any small regions in the plurality of small regions is unused by the result of the scan. The UE 1 selects any small region of the plurality of the small regions f1, f2, f3, and f4 as the small target region. Specifically, the UE 1 selects a small region which is unused or where usage rate is low as the small target region. Here, because any small region in the plurality of small regions is unused, the UE 1 selects the small target region by a random number, for example. Hereinafter, the following description will be given on the assumption that the UE 1 selects the small region f1.

In t2x, the UE 1 selects any one of the plurality of resources t21, t22, t23 in the small region f1. The following description will be given on the assumption that the UE 1 selects the resource t21 by a random number. The UE 1 transmits the Discovery signal by use of the resource t21, f1. After that, in every time t3x, t4x . . . , the UE 1 selects the resource in the small region f1.

Each other UE 100 (UE 2 to UE 5) selects the small target region as well as the UE 1 selects.

Next, one example of an operation of the UE 100 according to the operation example 1-1 is described by use of FIG. 17.

As shown in FIG. 17, in step S101, the UE 1 checks usage status of the Discovery region by scanning the Discovery region.

In step S102, the UE 100 selects the small target region where the usage rate is the lowest of the plurality of small regions.

In step S103, the UE 100 determines whether there are small regions where the usage rate is the lowest. When there are small regions where the usage rate is the lowest, the UE 100 performs a process of step S104. Otherwise, the UE 100 performs a process of step S106.

In step S104, the UE 100 selects one small region of the plurality of small regions where the usage rate is the lowest.

In step S105, the UE 100 set the selected small region to a small region (a small target region) to be used for transmitting the discovery signal.

On the other hand, in the step S106, the UE 100 sets the small region where the usage rate is the lowest to a small region (a small target region) to be used for transmitting the discovery signal.

The UE 100 having set the small target region selects a resource in the small target region. The UE 100 transmits the discovery signal by use of the selected resource.

(B) First Modification of the Operation Example 1-1

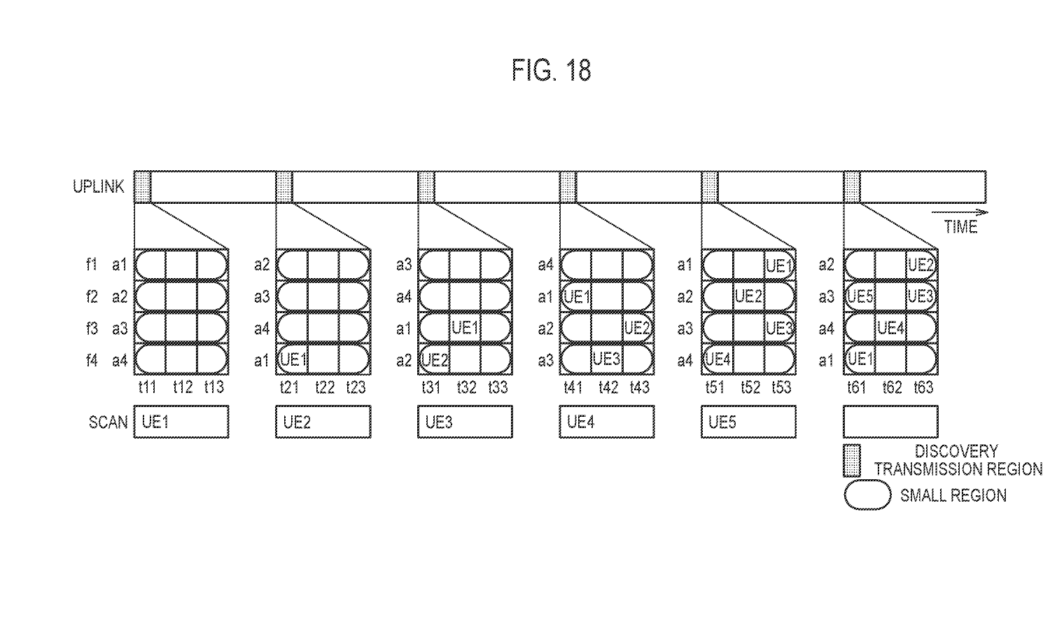

Next, the first modification of operation example 1-1 will be described below by use of FIG. 18. FIG. 18 is an explanation diagram for explaining the first modification of the operation example 1-1.

In the above operation example 1-1, the location of the small region (the small target region) in the frequency direction does not change depending on time. However, in the present modification, the location of the small region in the frequency direction changes depending on time. In other words, according to a rule, the small regions are arranged at a different location between adjacent Discovery regions. Accordingly, it is possible to average influence of interference based on another radio signal.

As shown in FIG. 18, each of small regions a1, a2, a3, and a4 is arranged at a location depending on a location of each of small target regions of a previous period. Specifically, the small area a1 is arranged in order of “f1->f4->f3->f2->f1”. Each other region (a2, a3, a4) is also arranged according to the same rule.

(C) Second Modification of the Operation Example 1-1

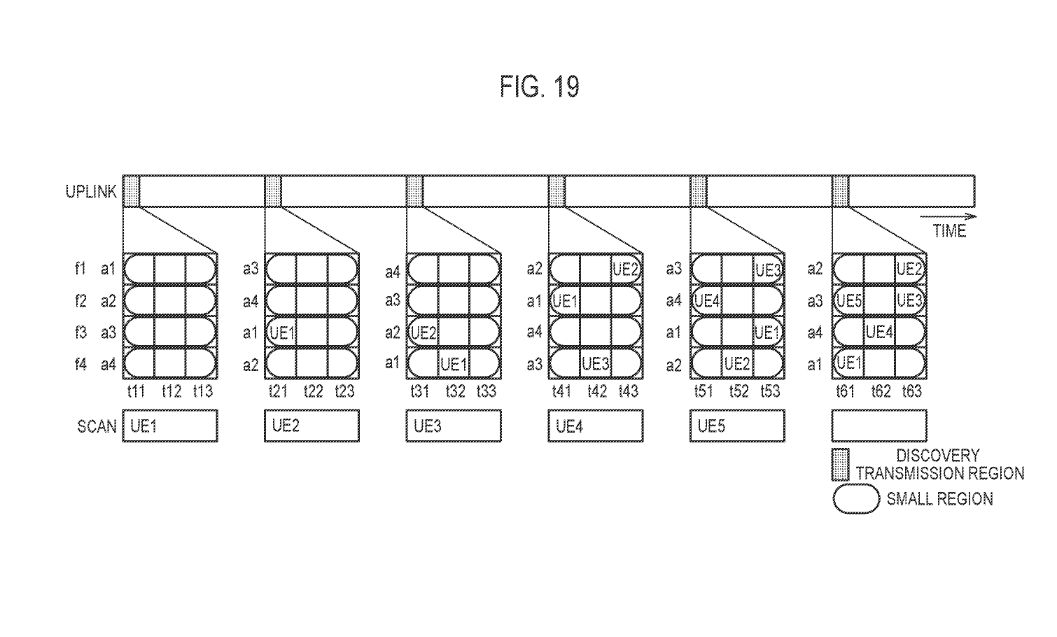

Next, the second modification of operation example 1-1 will be described below by use of FIG. 19. FIG. 19 is an explanation diagram for explaining the second modification of the operation example 1-1.

In the present modification, the location of the small region is arranged depending on the frame number of the small regions (the subframe number). For example, the frame number is indicated by the synchronization signal.

For example, in each of the plurality of Discovery regions, the arrangement pattern of the small regions is decided depending on the frame number of each of the small regions.

The arrangement pattern is decided according to the following formula, for example.

Pattern [Pcount][4]={{a1, a2, a3, a4}, {a3, a4, a1, a2}, {a4, a3, a2, a1}, {a2, a1, a4, a3}, {a3, a4, a1, a2}, {a2, a3, a4, a1}, . . . }

Here, arrangement pattern number: Pattern [n] is decided by (n=(Subframe/Tperiod) mod Pcount).

Subframe indicates a subframe number, Tperiod indicates a period of the Discovery region (for instance, t21-t11), and Pcount indicates a cyclic period of the arrangement pattern. Furthermore, as discussed below, a time stamp may be used instead of the Subframe.

Specifically, in FIG. 19, {a1, a2, a3, a4} of Pattern [1] is arranged at a location of {f1, f2, f3, f4} in the Discovery region of a first period, and {a3, a4, a1, a2} of Pattern [2] is arranged at a location of {f1, f2, f3, f4} in the Discovery region of a next period. The other small regions are similarly decided at the location of {f1, f2, f3, f4}, according to the arrangement pattern depending on the subframe number

(D) Operation Example 1-2

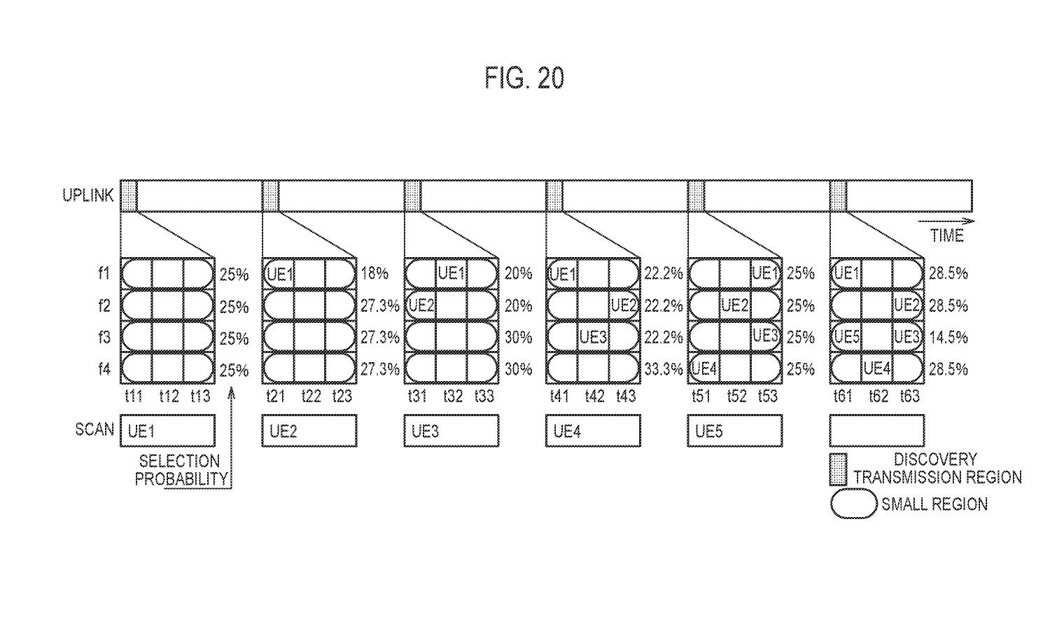

Next, the operation example 1-2 will be described below by use of FIG. 20. FIG. 20 is an explanation diagram for explaining the operation example 1-2.

In the operation example 1-2, the UE 100 selects the small target region on the basis of selection probability of each of the plurality of small regions.

Specifically, the UE 100 checks usage status of the Discovery region by scanning the Discovery region. The UE 100 calculates the selection probability depending on the usage rate of each of the plurality of small regions by the result of the scan. Specifically, the UE 100 sets a high selection probability for the small region which is unused or where the usage rate is low and a low selection probability for the small region where the usage rate is high. Thus, the UE 100 can preferentially select the small region which is unused or where the usage rate is low than the small region where the usage rate is high, as the small target region.

The UE 100 selects the small target region on the basis of a random number value in which the selection probability is reflected.

For example, as shown in FIG. 20, the selection probability of each of the small regions f1 to f4 is 25% because the UE 1 does not use any of the plurality of the small regions. In the next period, the UE 2 sets the selection probability of the small region f1 to 18% because the UE 1 is using the small region f1, and sets the selection probability of the other small regions f2 to f3 to 27.3%.

As shown in FIG. 20, Other UEs 100 (the UE 3 to the UE 5) also calculate the selection probability depending on the usage rate of each small region, and select the small target region on the basis of the selection probability in the same manner. Thus, it is possible to reduce a collision of the discovery signal because the possibility that the unused small region is selected as the target small region is higher.

(E) Operation Example 1-3

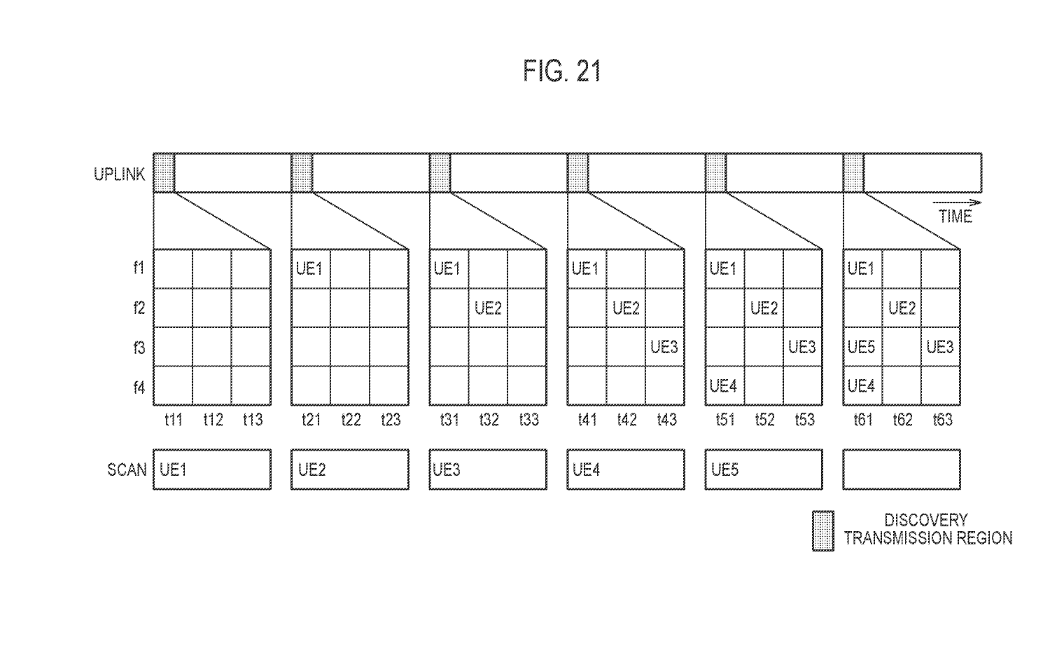

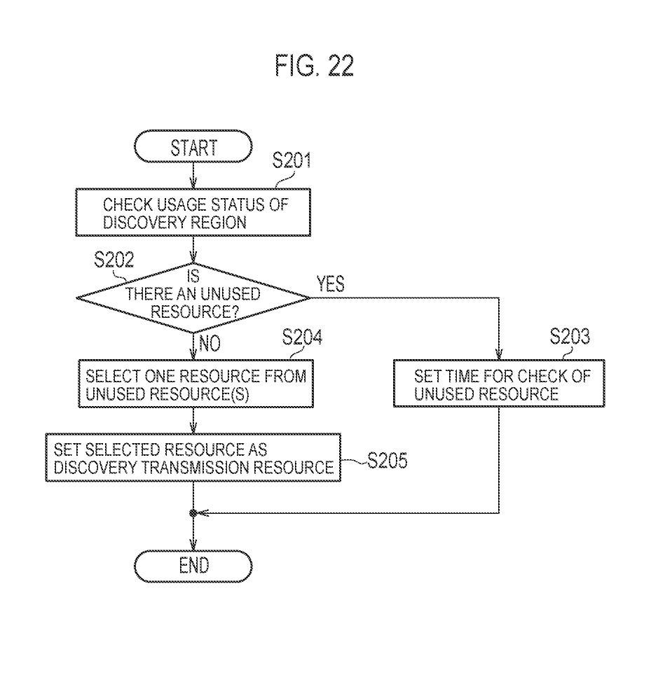

Next, the operation example 1-3 will be described below by use of FIG. 21 and FIG. 22. FIG. 21 is an explanation diagram for explaining the operation example 1-3. FIG. 22 is a flowchart for explaining one example of the operation example 1-3.

In the operation example 1-1, the small region includes the plurality of resources. On the other hand, in the operation example 1-3, the small region is configured by one resource (a time-frequency resource).

As shown in FIG. 21, the Discovery region is divided so that one resource becomes the small region. The Discovery region is divided into nine small regions (resources). In this case, the UE 100 can perform the following operation.

In FIG. 22, in step S201, the UE 100 checks usage status of the Discovery region by scanning the Discovery region.

In step S202, the UE 100 determines whether there is an unused resource in the plurality of resources (the small regions) by the result of the scan. When the UE 100 determines that there is not the unused resource, the UE 100 performs a process of step S203. Otherwise, the UE 100 performs a process step S204.

In step S203, the UE 100 sets time for recheck of the unused resource, and then the UE 100 stops the process.

On the other hand, in step S204, the UE 100 selects one resource from the unused resource(s).

In step S205, the UE 100 sets the selected resource as the Discovery transmission resource (the small target region) for transmitting the discovery signal.

The UE 100 transmits the discovery signal by use of the selected resource. As shown in FIG. 21, where the UE 100 (for example, UE 1) continuously and periodically transmits the discovery signal, the UE 100 transmits the discovery signal by use of an resource of a next period depending on the location of the selected resource in a previous period.

Furthermore, a resource (the small region) is arranged depending on the frequency band of the resource and/or the timestamp of the resource in a case where the second modification of the operation example 1-1 is applied in the present operation example.

(2) Reselection of the Small Target Region

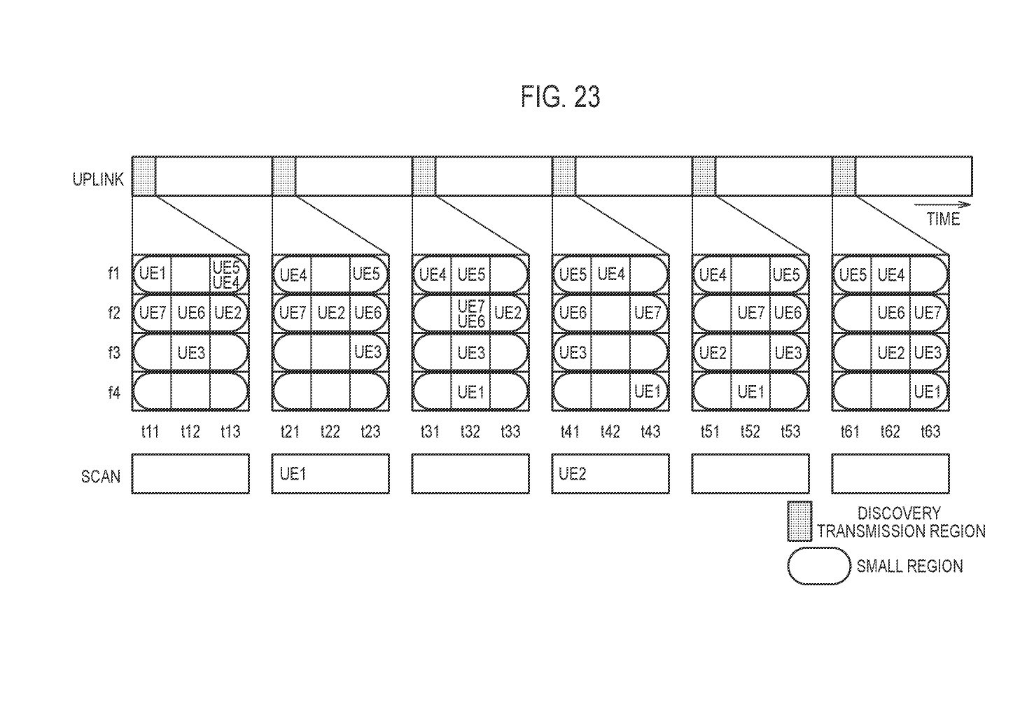

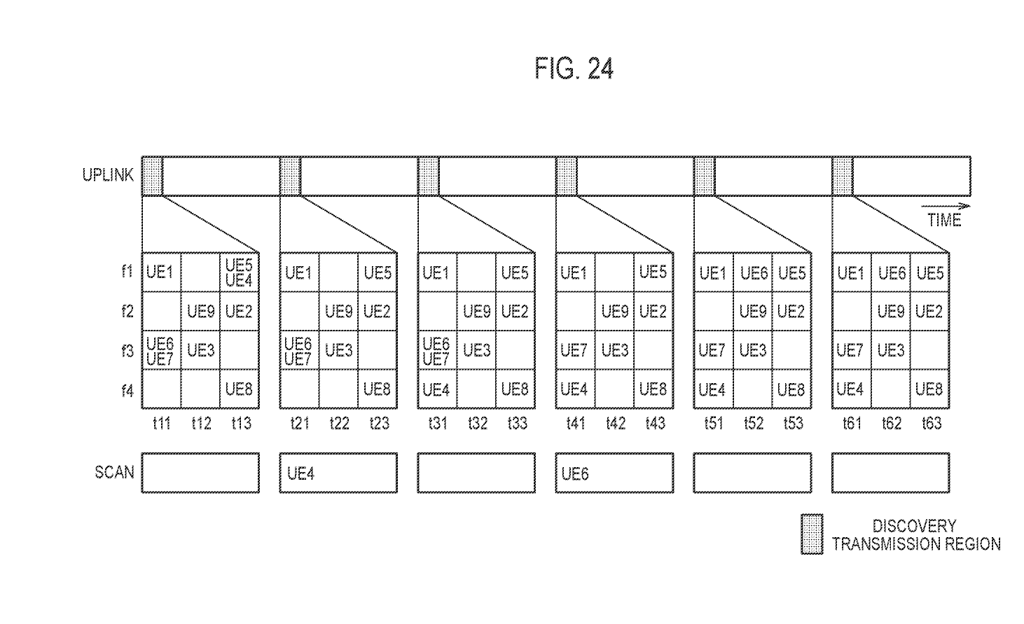

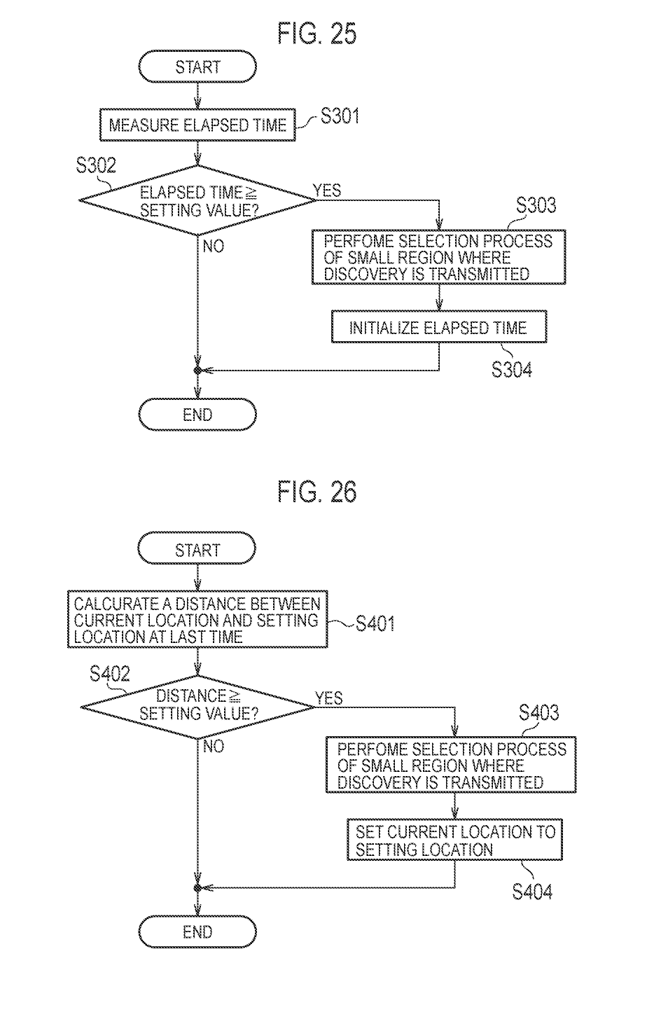

Next, a reselection of the small target region will be described below by use of FIG. 23 to FIG. 26. FIG. 23 and FIG. 24 are a configuration diagram of a radio frame in the mobile communication system according to the present embodiment. FIG. 25 and FIG. 26 are a flowchart for explaining an operation of an UE 100 according to the present embodiment.

Where the UE 100 continuously and periodically transmits the discovery signal, the UE 100 continues to transmit the discovery signal by the small target region (in other words, the configured small region). On the other hand, where the UE 100 continuously and periodically transmits the discovery signal and where a predetermined condition is satisfied, the UE 100 reselects the small target region.

For example, as shown in FIG. 23, because the predetermined condition is satisfied, the UE 1 reselects the small target region in t2x. The UE 2 reselects the small target region in t4x in the same way.

As shown in FIG. 24, in the case where the small region is one resource, the UE 100 also can reselect the small target region (the resource) in the same way.

The predetermined condition is, for example, a condition of one of the first to third below.

Firstly, the predetermined condition is a condition that elapsed time from selecting the small region (the small target region) is greater than or equal to a threshold. Thus, the UE 100 selects the small target region with respect to each time period based on the threshold.

Specifically, as shown in FIG. 25, in step S301, the UE 100 measures the elapsed time from selecting the small target region.

In step S302, the UE 100 determines whether the elapsed time is greater than or equal to a setting value (the threshold). When the elapsed time is greater than or equal to the setting value, the UE 100 performs a process of step S303. Otherwise, the process ends.

In step S303, the UE 100 performs the selection process of the small region (the small target region) where the discovery signal is transmitted.

In step S304, the UE 100 initializes the elapsed time.

Thus, even though a situation changes due to change of time when the UE 100 transmits the discovery signal, it is possible to reduce the collision of the discovery signals appropriately.

Secondly, the predetermined condition is a condition that a distance between a current location of the UE 100 and a point where the small target region is selected is greater than or equal to a threshold. Thus, the UE 100 selects the small target region depending on the distance from the point where the small target region is selected.

Specifically, as shown in FIG. 26, in step S401, the UE 100 measures the current location. Next, the UE 100 calculates the distance between the current location and a setting location which is the point where the small target region is selected at last time.

In step S402, the UE 100 determines whether the calculated distance is greater than or equal to the threshold. Where the calculated distance is greater than or equal to the setting value, the UE 100 performs a process of step S403. Otherwise, the process ends.

In step S403, the UE 100 performs the selection process of the small region (the small target region) where the discovery signal is transmitted.

In step S404, the UE 100 sets the current location to the setting location.

Thus, even though a situation changes due to change of location where the UE 100 transmits the discovery signal, it is possible to reduce the collision of the discovery signals appropriately.

Thirdly, the predetermined condition is a condition that a change in usage rate of the plurality of small regions is greater than or equal to a threshold. Alternatively, the predetermined condition may be a condition that increasing or decreasing the usage rate of the plurality of small regions is greater than or equal to a threshold.

The UE 100 continues to monitor the small regions by continuing to scan scannable small regions of the plurality of small regions. It is noted that the scannable small region is a region which is arranged in time other than time in which the UE 100 transmits the discovery signal. In other words, the scannable small region is a small region which does not be arranged to the same time location as the small target region.

When a change in the usage rate of the plurality of small regions is greater than the threshold as a result of the monitor, the UE 100 starts the selection of the small target region. Specifically, the UE 100 determines whether a change value calculated by comparing currently usage rate (for example, an average) of the plurality of small regions and a reference value is greater than or equal to the threshold.

In order to calculate the change of the usage rate of the plurality of small regions, the UE 100 sets the usage rate of the plurality of small regions to the reference value on the basis of the result of the monitor.

Thus, the UE 100 can appropriately reduce the collision of the discovery signal because of averaging the usage rate of the plurality of small regions. Especially, in the case where the usage rate of the plurality of small regions increases, this condition is effective.

Furthermore, the threshold may be a preconfigured value (Pre-config. value). The threshold may be determined depending on at least one of a cell, a location of the UE 100, time and a congestion state of the UEs 100 ‘(for example, the usage state of the Discovery regions) by the UE 100 or eNB 200.

(3) Collision Notification

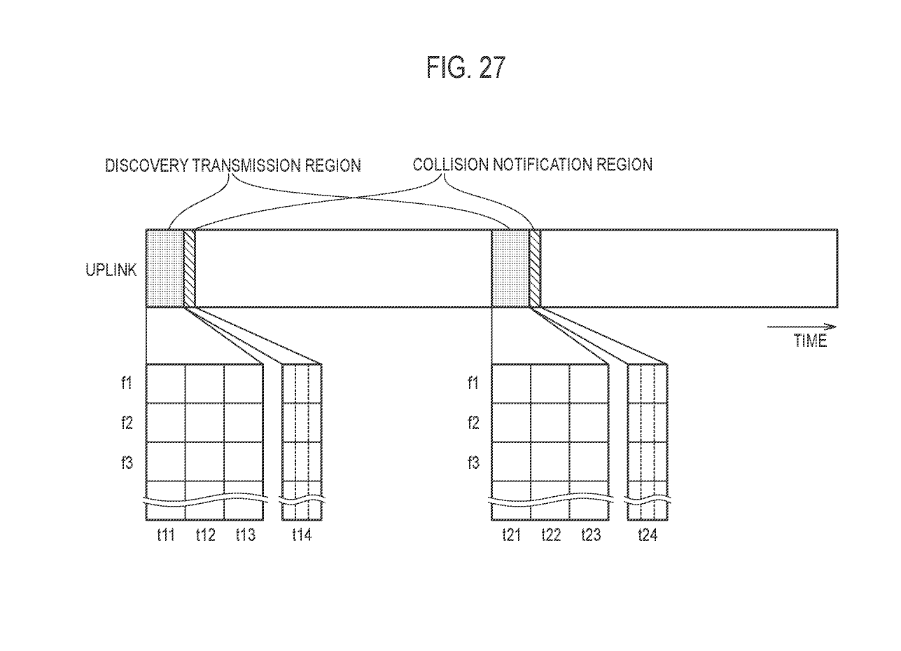

Next, a collision notification will be described below by use of FIG. 27 to FIG. 31. FIG. 27 to FIG. 29 are a configuration diagram of a radio frame in the mobile communication system according to the present embodiment.

As shown in FIG. 27, each collision notification region is periodically arranged after each of the plurality of Discovery regions. The collision notification region is time-frequency resources to be used for transmitting the collision notification.

The collision notification is information indicating a collision of the discovery signals. When the UE 100 having scanned the Discovery region receives a radio signal that cannot be decoded, the UE 100 determines that the discovery signals collide, and then the UE 100 transmits the collision notification.

One resource for transmitting the collision notification is arranged with respect to one small region in FIG. 27. However, one resource for transmitting the collision notification may be arranged with respect to the plurality of small regions. In this case, the UE 100 transmitting the collision notification may transmits the collision notification by use of a signal (for example, a coded signal) so that each the UEs 100 transmitting the discovery signal is separately instructed.

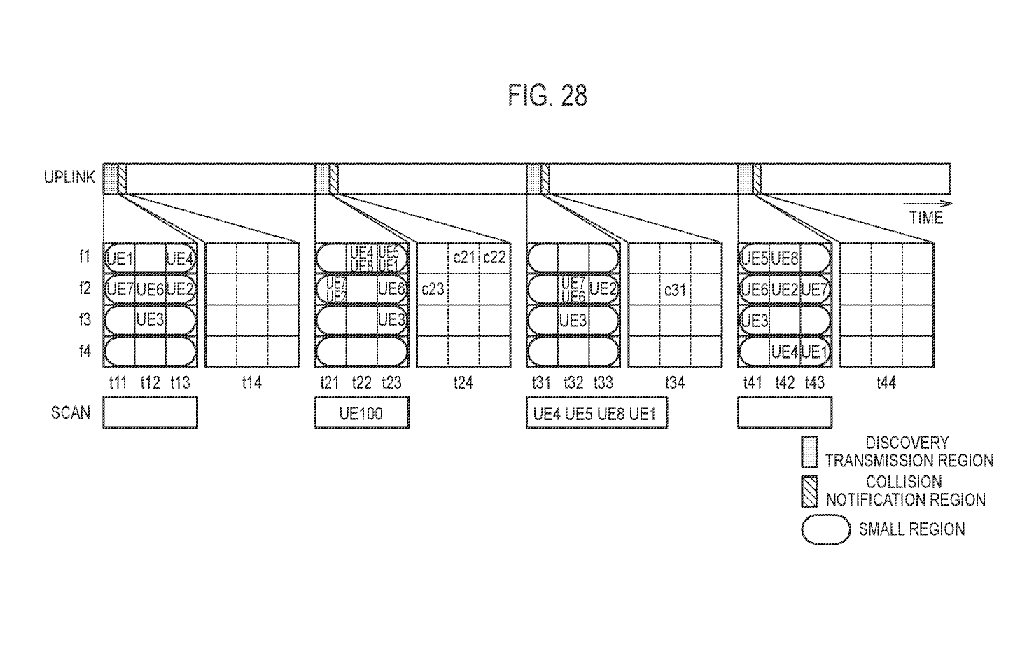

For example, in FIG. 28, it is assumed that the UE 5 and the UE 8 have moved near other UEs.

The UE 100 scans the Discovery regions (t2x), and then the UE 100 transmits the collision notification (c21, c22, c23). Each UE (the UE 1, the UE 4, the UE 5, and the UE 8) having transmitted the discovery signal used the small region (f1, t2x) scans the next Discovery regions (t3x), and then checks the usage state. Each UE (the UE 1, the UE 4, the UE 5, and the UE 8) determines that the usage rate of the plurality of the small regions (f1, f4) is low, and then each UE selects the small target region from the plurality of the small regions (f1, f4).

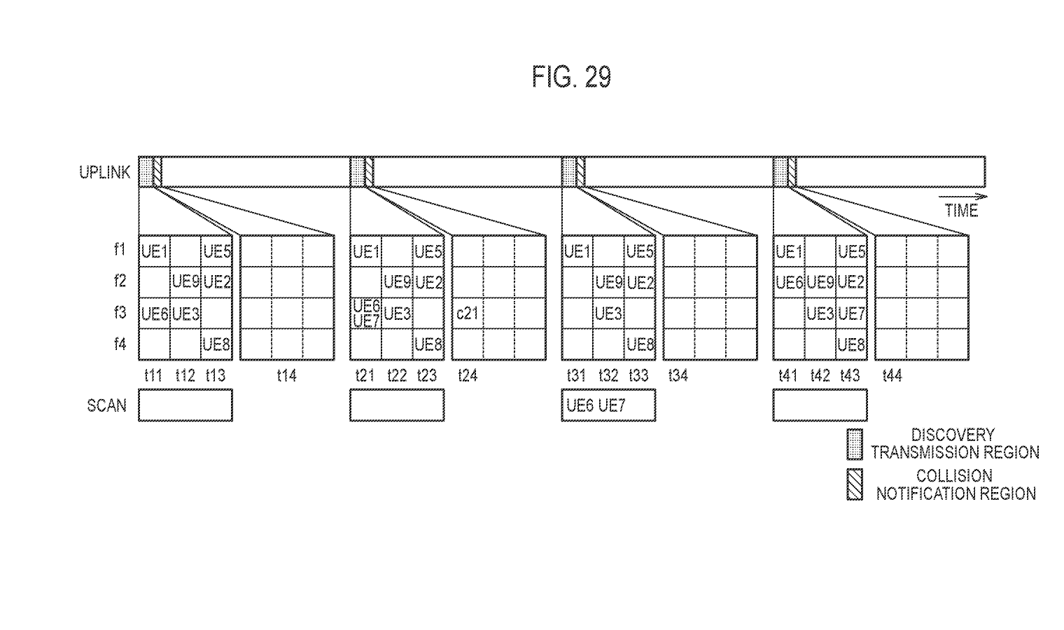

Also, in a case where the small region is one resource as shown in FIG. 29, each UE (the UE 6, and the UE 7) can reselect the small target region (the resource) on the basis of the collision notification.

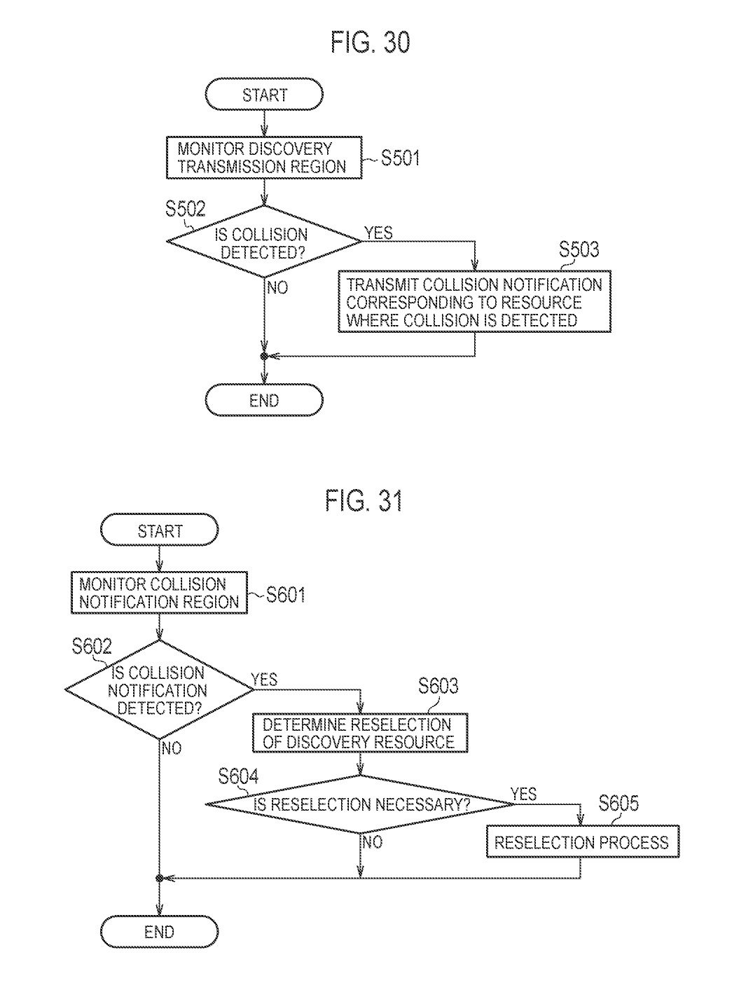

Next, one example of an operation of the UE 100 relevant to the collision notification will be described by use of FIG. 29 and FIG. 31. FIG. 30 is a flowchart for explaining a transmission operation of the collision notification of the UE 100 according to the present embodiment. FIG. 31 is a flowchart for explaining a reception operation of the collision notification of the UE 100 according to the present embodiment.

Firstly, the operation of UE 100 transmitting the collision notification will be described.

As shown in FIG. 30, in step S501, the UE 100 monitors the Discovery region by scanning the Discovery region.

In step S502, the UE 100 determines whether a collision is detected. Specifically, when the UE 100 receives a signal that cannot be decoded although a receiving power is detected by the scan of the Discovery region, the UE 100 determines that the collision of the discovery signal is detected. When the collision of the discovery signal is detected, the UE 100 performs a process of step S503. Otherwise, the process ends.

In step S503, the UE 100 transmits a collision notification by use of a resource corresponding to the resource (the small region) where the collision is detected within the collision notification region.

Next, an operation of UE 100 receiving the collision notification will be described.

As shown in FIG. 31, in step S601, the UE 100 monitors the collision notification region by scanning the collision notification region. The UE 100 may monitor an only resource within the collision notification region corresponding to the discovery signal which the UE 100 itself has transmitted.

In step S602, the UE 100 determines whether the collision notification has been detected. When the collision notification has been detected, the UE 100 performs a process of step S603. Otherwise, the process ends.

In step S603, the UE 100 determines whether the UE 100 reselects the Discovery resource (the small target region). In other words, the UE 100 considers whether or not to reselect. For example, when the collision notification does not be transmitted by use of a resource corresponding to the discovery signal having been transmitted by the UE 100 itself within the collision notification region, the UE 100 determines that the reselection is unnecessary. Alternatively, the UE 100 may determine whether the UE 100 reselects on the basis of random value.

In step S604, the UE 100 determines whether the reselection is necessary. When the UE 100 determines that the reselection is necessary, the UE 100 performs a process of step S605. Otherwise, the process ends.

In the step S605, the UE 100 performs the reselection process of the small target region.

Furthermore, where the UE 100 selects the small target region on the basis of the selection probability like the operation example 1-2, the process in which the selection probability of the selected small region is reduced may be performed.

As described above, it is possible to reduce the collision of the discovery signal because the collision notification prompts the reselection of the small target region.

### Other Embodiments

The UE 100 according to another embodiment determines, on the basis of a subscriber identifier assigned to an user of the UE 100, a D2D resource assignment pattern such that a radio resource used for D2D communication is dispersed in the frequency direction and/or the time direction. That is, in another embodiment, the D2D resource assignment pattern is determined by using the subscriber identifier, instead of the RNTI according to the above-described first to third embodiments. The subscriber identifier is, for example, IMSI (International Mobile Subscriber Identity) stored in an SIM (Subscriber identity module) that is mounted in the UE 100.

Further, the above-described D2D resource assignment pattern is an assignment pattern in the frequency/time direction; however, the D2D resource assignment pattern may include a transmission power and/or a transmission directivity pattern, or may be a combination thereof. By dispersing the transmission power and/or the transmission directivity pattern, a ratio between desired wave power and interference power (SIR) is randomized as viewed from a reception terminal, therefore, the effect of reducing incommunicable UEs is obtained.

In addition, in the above-described first to third embodiments, the network (eNB 200) assigns an RNTI to the UE 100; however, the UE 100 may assign an RNTI. For example, the UE 100 which becomes a cluster head assigns an RNTI to another UE 100. Such a method is particularly effective for a case in which D2D communication is performed out of coverage.

In each of the above-described fourth embodiment, the discovery signal as the D2D control signal is described as an example. However, it is not limited thereto.

The present invention can be applied to a control signal (SA: Scheduling Assignment) indicating a location of data resource to be used for transmitting the D2D communication data in the same way. Also, the D2D control signal is a synchronization signal (D2DSS) to be used for establishment the synchronization for the D2D communication.

Furthermore, the small regions including the plurality of resources are divided in the time axis direction (horizontal type). However, the small regions may be divided in the frequency axis direction (vertical type).

In of the above-described fourth embodiment, each operation example may be combined and then the combined operation examples may be performed, as necessary.

Furthermore, in each of the above-described embodiments the LTE system as one example of a cellular communication system was described; however, it is not limited thereto. The present invention may also be applied to systems other than the LTE system.

[Additional Statement]

(1) Introduction

The following working assumptions are agreed.
Discovery message transmission resource configuration consists of a plurality of subframes and a discovery period.
   The number of discovery subframes and the discovery period are semi-statically configured at least when in coverage.
   Individual discovery message transmission resources are not CDM.
   All individual discovery message transmission resources are the same size.
Power consumption of RRC_Idle UEs when considering resource allocation for discovery is studied.

Here, D2D resource selection for discovery transmissions of Type 1 scheme will be described.

(2) Resource Selection for Discovery of the Type 1 Scheme

D2D discovery resources are allocated periodically. FIG. 15 is an example of D2D discovery resources. Discovery of the Type 1 scheme is non-UE specific scheme where a UE with an intention to be discovered selects a resource for transmitting its discovery signal.

The simplest approach is to randomly select resources. However, random resource selection scheme may have relatively higher probability of collisions. In order to reduce the probability of collisions, we propose subset division random resource selection scheme as one example.

(3) Subset Division Random Resource Selection

In this section, we describe the subset division random resource selection scheme.

The basic concepts are as follows.
A UE that has an intention to transmit D2D discovery signal must scan the potential discovery signal resources (Discovery regions) before transmitting a discovery signal.
For example, as shown in FIG. 9, the discovery resources are further partitioned into N number of subsets (small regions). Each subset consists of X number of frequency-bands and Y number of subframes. In this case, different frequency subbands (frequency-division) are used to create subsets. In another approach, a group of subframes (time-division) or a combination of both time and frequency division can be used.
UEs must follow the following rules.

Rule 1: If a UE scans and detects no other discovery signal, then it can randomly select a subset for its own discovery signal transmission. The UE 100 can transmit on any resource within the selected subset. The UE 100 selects the same subset in the subsequent discovery subframes.

Rule 2: If a UE 100 scans and detects another discovery signal, then the UE must avoid using the associated subsets for its discovery signal. The UE 100 selects a subset with no discovery signal present within that subset.

Rule 3: If a UE 100 scans and finds all the subsets are occupied by other discovery signals, then it selects a subset with the least number of discovery signals present in the subset.

Rule 4: After certain time-period T, all discovery signals are reset and the above process repeats.

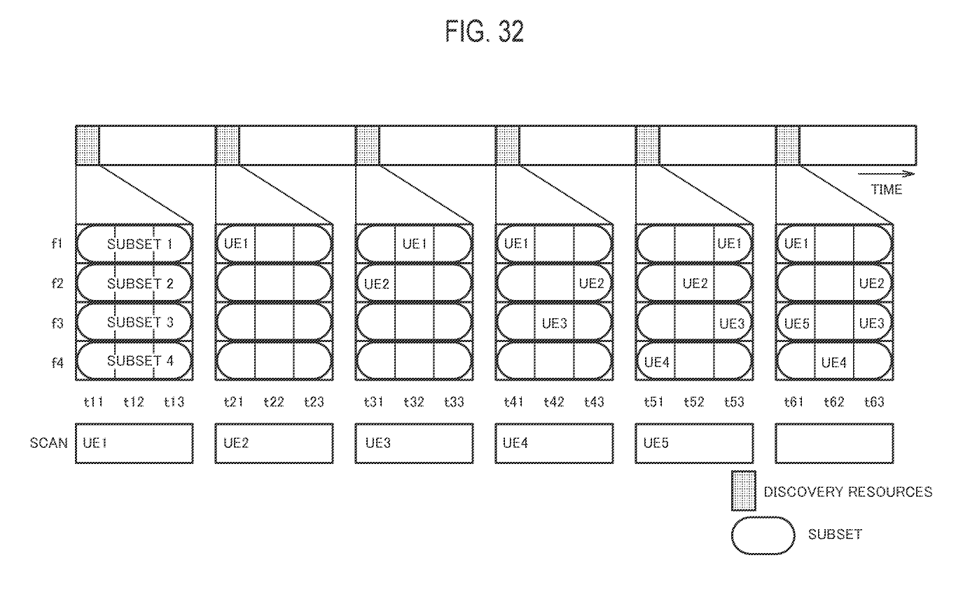

FIG. 32 shows an example using the above rules. It is assumed that a channel is split into 4 subsets. Each subset is 4 frequency-bands wide and 3 subframes long within the D2D discovery resources. When the above rules are applied, UEs 100 (a UE 1 to a UE 6) select their own D2D transmission resources as follows.

1) The UE 1 scan subsets and select subset 1 because no other UE is transmitting its discovery signal in the subset 1. It is noted that the UE 1 could have selected subset 2, subset 3 and subset 4 since the UE 1 is the first UE to select resources for its discovery signal.

2) Then a UE 2 scan all the subsets and finds subset 1 being taken. The UE 2 is allowed to select either the subset 2, 3 or 4. The UE 2 selects the subset 2. A UE 3 and a UE 4 follow the same procedure as the UE 2.

3) The UE 1, the UE 2, the UE 3 and the UE 4 have occupied all of the 4 subsets respectively. Then a UE 5 scan all the subsets and select the subset 3 because all subsets have same number of discovery signal transmissions. The UE 5 could have selected the subset 1, the subset 2, the subset 3 and the subset 4.

4) A UE 6 (not shown in the figure) can select any subset except the subset 3 because the subset 4 does not have the least number of discovery signal transmissions.

(4) Comparisons Between Random and Proposed Selection

We performed a simple simulation for comparison between random resource selection scheme and the above subset division random resource selection scheme. The simulation assumptions are described in Appendix A.

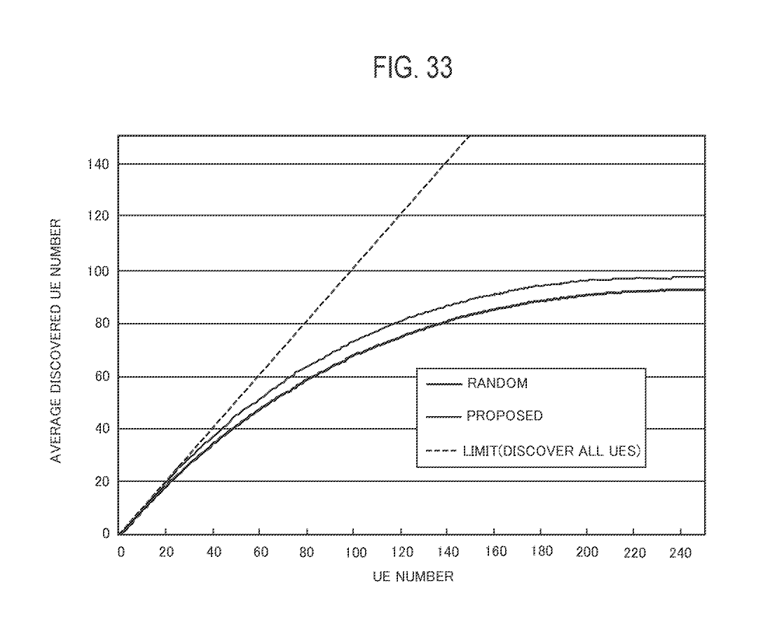

As shown in the FIG. 33, the subset division random resource selection scheme performs better than the random selection scheme. In the case of 250 UEs, about 5% performance gain is shown. FIG. 33 also shows the performance of both the schemes degrades as the number of UEs to be discovered increases.

We conclude that, to reduce the probability of collisions and increase the number of discoverable UEs, a collision reduction algorithm such as subset division random resource selection scheme must be considered for discovery of D2D Type 1 scheme.

Proposal: To reduce the probability of collision and increase the number of discoverable UEs, a collision reduction algorithm, for example, subset division random resource selection scheme must be considered for discovery of D2D Type 1 scheme.

(5) Conclusions

We considered 2 basic resource selection schemes for discovery of D2D type 1 scheme. Based on the above analysis, we propose the following.

Proposal: To reduce the probability of collision and increase the number of discoverable UEs, a collision reduction algorithm, for example, subset division random resource selection scheme must be considered for discovery of D2D Type 1 scheme.

(6) Appendix A: Simulation Assumptions

1) A discovery resource consists of 2RB pairs.

2) The size of discovery resources per Discovery period is 25*10 resources.

3) A UE 100 cannot discover any UEs 100 in the resources where collisions occur. That mean the distances of UEs 100 are not considered.

4) The number of discovered UEs 100 is averaged per discovery period.

It is noted that the entire content of Japanese Patent Application No. 2013-176504 (filed on Aug. 28, 2013) and U.S. Provisional Application No. 61/934,413 (filed on Jan. 31, 2014) is incorporated in the present specification by reference.

### INDUSTRIAL APPLICABILITY

As described above, the user terminal and the mobile communication system according to the present invention are possible to reduce a load on a network and to prevent D2D communication from becoming disabled due to interference. Thus, they are useful in the mobile communication field.

1. A user terminal used in a mobile communication system, comprising:
a controller configured to determine, when D2D communication that is direct device-to-device communication is performed in a terminal group including a plurality of user terminals, an assignment pattern of a radio resource used for the D2D communication, wherein
the controller determines, on the basis of a temporary identifier assigned from a network of the mobile communication system, the assignment pattern such that the radio resource used for the D2D communication is dispersed in a frequency direction and/or a time direction.

2. The user terminal according to claim 1, wherein the temporary identifier is a group identifier for identifying the terminal group, and
the controller determines, on the basis of the group identifier assigned from the network, the assignment pattern such that the radio resource used for the D2D communication is dispersed in the frequency direction and/or the time direction.

3. The user terminal according to claim 2, wherein the group identifier includes different intra-group identification information for each user terminal included in the terminal group, and
the controller determines, on the basis of the intra-group identification information included in the group identifier assigned to the user terminal, whether to perform transmission or to perform reception in the radio resource used for the D2D communication.

4. The user terminal according to claim 2, wherein the terminal group is a group including a plurality of user terminals between which device-to-device synchronization is performed.

5. The user terminal according to claim 2, wherein the terminal group is a group including a plurality of user terminals between which device-to-device synchronization is performed and which transmit and receive data through the D2D communication.

6. The user terminal according to claim 5, wherein a plurality of data distribution systems are defined as a data distribution system for transmitting and receiving data through the D2D communication,
the plurality of data distribution systems are at least two of unicast distribution, group cast distribution, and broadcast distribution, and
the terminal group is set for each of the data distribution systems.

7. The user terminal according to claim 6, wherein when the user terminal belongs to a plurality of terminal groups that are set for each of the data distribution systems, a plurality of group identifiers corresponding to the plurality of terminal groups are assigned to the user terminal, and
the controller determines, on the basis of the plurality of group identifiers, the assignment pattern of the radio resource used for the D2D communication for each of the plurality of terminal groups.

8. The user terminal according to claim 1, wherein the temporary identifier is a terminal identifier for identifying each user terminal, and
the controller determines, on the basis of the terminal identifier assigned from the network to a representative user terminal included in the terminal group, the assignment pattern such that the radio resource used for the D2D communication is dispersed in the frequency direction and/or the time direction.

9. The user terminal according to claim 8, wherein the terminal identifier includes different intra-group identification information for each user terminal included in the terminal group, and
the controller determines, on the basis of the intra-group identification information included in the terminal identifier assigned to the user terminal, whether to perform transmission or to perform reception in the radio resource used for the D2D communication.

10. A user terminal used in a mobile communication system, comprising:
a controller configured to determine, when D2D communication that is direct device-to-device communication is performed in a terminal group including a plurality of user terminals, an assignment pattern of a radio resource used for the D2D communication, wherein
the controller determines, on the basis of a subscriber identifier assigned to a user of the user terminal, the assignment pattern such that the radio resource used for the D2D communication is dispersed in a frequency direction and/or a time direction.

11. A mobile communication system that supports D2D proximity service which enables direct communication without passing through a network, comprising:
a user terminal selecting a small target region to be used for transmitting a D2D control signal from a plurality of small regions included in each of a plurality of D2D control resource regions provided periodically in a time axis direction, wherein
the user terminal selects the small target region depending on a result of scanning the plurality of small regions.

12. The mobile communication system according to claim 11, wherein each of the plurality of D2D control resource regions is a time-frequency resources used to transmit a discovery signal for discovery a proximity terminal, and
the user terminal transmits the discovery signal as the D2D control signal by use of the small target region.

13. The mobile communication system according to claim 11, wherein the user terminal preferentially selects a small region which is unused or where usage rate is low than a small region where the usage rate is high, as the small target region.

14. The mobile communication system according to claim 13, wherein the user terminal calculates selection probability depending on the usage rate in regard to each of the plurality of small regions, and
the user terminal selects the small target region on the basis of the selection probability.

15. The mobile communication system according to claim 11, wherein the small target region is arranged at a same location in each of the plurality of D2D control resource regions.

16. The mobile communication system according to claim 11, wherein the small target region is arranged at a different location from a location of a small target region of a previous period, depending on the location of the small target region of the previous period.

17. The mobile communication system according to claim 11, wherein the small target region is arranged depending on a frame number of the small target region or a timestamp of the small target region.

18. The mobile communication system according to claim 11, wherein the small target region includes a plurality of time-frequency resources, and
the user terminal transmits the D2D control signal by use of one time-frequency resource of the plurality of time-frequency resources.

19. The mobile communication system according to claim 11, wherein the user terminal reselects the small target region when the user terminal continuously and periodically transmits the D2D control signal and when a predetermined condition is satisfied.

20. The mobile communication system according to claim 19, wherein the predetermined condition is a condition that elapsed time from selecting the small target region is greater than or equal to a threshold.

21. The mobile communication system according to claim 19, wherein the predetermined condition is a condition that a distance between a current location of the user terminal and a point where the small target region is selected is greater than or equal to a threshold.

22. The mobile communication system according to claim 19, wherein the predetermined condition is a condition that a change in usage rate of the plurality of small regions is greater than or equal to a threshold.

23. The mobile communication system according to claim 11, comprising: another user terminal being capable of reception a D2D control signal transmitted by use of the small target region, wherein
the user terminal reselects the small target region when the user terminal receives, from the other user terminal, a collision notification indicating that the D2D control signal has collided after the D2D control signal transmitted by use of the small target region by the user terminal.

24. The mobile communication system according to claim 11, comprising: another user terminal, wherein
the user terminal transmits collision information indicating that the D2D control signal has collided when the user terminal detects a collision of the D2D control signal transmitted by the other user terminal in response to scanning the plurality of small regions.
